(19) United States
(12) Patent Application Publication
(10) Pub. No.: US 2026/0127121 A1
(43) Pub. Date: May 7, 2026

(54) HIGH BANDWIDTH MEMORY STRUCTURES FOR COMPUTER PROCESSOR UNITS

(71) Applicants: Raminda U. Madurawe, Sunnyvale, CA (US); Joseph T. DiBene, II, Watsonville, CA (US)

(72) Inventors: Raminda U. Madurawe, Sunnyvale, CA (US); Joseph T. DiBene, II, Watsonville, CA (US)

(21) Appl. No.: 18/936,923

(22) Filed: Nov. 4, 2024

(51) Int. Cl. G06F 9/30; G06F 13/16

(52) U.S. Cl. CPC G06F 13/1689; G06F 13/16; G06F 13/40

(57) ABSTRACT

A computer processing unit (CPU) comprising an instruction unit and an accelerator unit comprises a first configuration for concurrent instruction and accelerator operation using an instruction-bus for instruction-data and a data-bus for compute-data transfers respectively; and a second configuration for accelerator operation using both buses for compute-data transfer to boost accelerator performance. A CPU comprises a configurable sense-node in cache-memory comprising a detect RC-delay 100-times faster than a memory bit-line settling RC-delay to selectively detect, and latch a plurality of settled bit-line voltages in quick succession during a memory access, and transmit the latched data sequentially in evenly distributed time steps in one or more data-buses. One or more cache-memory address signals configurably couple a plurality of data-words to one or more buses to increment one or more memory address signals and configure DDR, QDR and higher data rate modes of data transfer. Disclosed embodiments enhance high performance computing data-bandwidth.

This application is related to Provisional Application Ser. No. 63/468,059 entitled “Macro-Processor Architectures”, filed on 22 May 2023 and Provisional Application Ser. No. 63/468,061 entitled “Content-Compute Processors and Architectures”, filed on 22 May 2023, and list as inventor Mr. Raminda U. Madurawe, the contents of which are incorporated-by-reference.

This application is also related to application Ser. No. 18/656,824 entitled “Macroprocessor Architectures for Pipelined Flexible-Function Computing”, application Ser. No. 18/656,836 entitled “Content Compute Processors and Architectures”, application Ser. No. 18/656,854 entitled “Interconnect Structures for Configurable CPU Pipelines”, all filed on 7 May 2024, and application Ser. No. 18/656,854 entitled “Control Units for Heterogeneous Compute Processors”, filed on 22 May 2024, all of which list as inventor Mr. Raminda U. Madurawe, the contents of which are incorporated-by-reference.

### BACKGROUND

### 1. Field of the Invention

The present invention relates to a plurality of integrated circuits, and further relates to central processor units (CPU), field programable gate arrays (FPGA), and application specific integrated circuits (ASIC). CPUs include microprocessors, microcontrollers and other instruction-based processors comprising one or more processor cores. FPGAs include other types of programmable logic devices (PLDs). ASICs include domain-specific-accelerators (co-processors such as TPUs, NPUs & GPUs & DSAs) and in-memory compute units (CIM). Integrated circuits include hardware architectures (HWA) and instruction set architectures (ISA). Specifically, the invention relates to high bandwidth cache memories and segmented bus architectures for multi-core CPU systems for high performance computing (HPC). The invention includes configurable coherent cache data storage structures, data communication bus structures, and control units in HWA. A CPU comprises an instruction-bus to receive instruction-data and a data-bus to receive compute-data, wherein said instruction-bus and data-bus fetch compute-data to increase HPC bandwidth. The CPU further comprising a configurable accelerator to utilize the increased data bandwidth. A data-bus in a CPU comprising a configurable means of transferring data within a clock cycle at one of a single data rate, a double data rate, and a quadruple data rate to boost data bandwidth. Said data-bus further comprising one or more latches comprising a means of early signal transition detection to reduce signal transmission delays.

### 2. Prior Art

A microprocessor, also known as a CPU, is a widely used first embodiment of a programmable device in the Integrated Circuits (IC) industry. The programming is done by executing ISA-instructions. It comprises a plurality of hardware structures (arranged in the Hardware Architecture HWA) to process the pre-defined instruction-set (the ISA). The matched HWA-ISA duality allows a control-unit to select a plurality of dedicated hardware structures to execute all instructions using control-signals. Each activity takes one or more clock cycles. Compiled instructions reside in memory, in the form of data-strings, and when the instruction is loaded (or read) into an instruction-register (IR), an IR decoding circuit instructs the control unit to provide hardware functions needed to execute the instruction. Hardware units manipulate compute-data associated with instructions.

Instruction-data and compute-data may reside in different segments of an external hard-drive of a computer. Hereafter the term instructions refer to instruction-data and the term data refers to compute-data. A CPU utilizes a cache memory hierarchy to fetch instructions and data from the external memory using an Operating-System (OS) that also runs on a CPU dedicated for the OS known as the host-CPU. Some instructions move data (such as move, load and store), and some instructions compute data (such as AND, MULT, ADD). When instructions manipulate data, the instructions and data need to be synchronized. The cache memory hierarchy ensures accuracy of data, and when multiple copies of the same data reside in multiple memory locations, all data-fields must match, aka data-coherency. Only a store command can disturb the coherency. In this discussion, it is assumed that a CPU chip has three levels of cache memory: L3-cache (L3$), L2-cache (L2$) & L1-cache (L1$). It could have fewer or greater memory levels. Instructions and data move from External Memory to L3$ to L2$ to L1$ sequentially to feed the CPU, and work in reverse order to save computed results back in the hard-drive. Instructions only move one-way, towards L1$, while data move both-ways. Drivers ensure the directionality of instruction and data movement. Local bus structures (drivers and wires) are used to move data between storage units. The number of wires and a data clocking frequency determine the data bandwidth. To feed one or more CPUs, the bus structures must provide required instruction and data bandwidth to the CPU. A bus grid is also known as a mesh. Clock frequency relates to data bandwidth while transmission latency determines the delay time.

From external memory, data moves in pages to maximize performance. It is common to use 4 KB or 8 KB pages for data transfer. External hard drive data addresses, are tracked using page tables by the OS to ensure on-chip stored data accuracy. All cache memories track data using address-tags to maintain matching. Both instructions and data reside in Hard-Drives, L3$ and L2$ memory transfer data in blocks of a page-size. In modern day computer Harvard-Architectures, the L1$ is divided into two separate memories, an I-cache (L1$I) and a D-cache (L1$D). A common bus couples L2$-L1$I to fetch unidirectional instructions, and L2$-L1$D to load and store bidirectional input/output data. Instruction bandwidth and data bandwidth are balanced for optimal CPU performance. As an example, 1024-wire bus can transfer 4 KB page in 32 clock-cycles, and usually the same bus is used to couple L2$ to both L1$I and L1$D. 2048-wire bus would double the data bandwidth. A RISC processor does not execute instructions out of L1$I and L1$D directly, instead it uses intermediate register banks having much faster data access times to operate. Both use a two-step data transfer mechanism. Instructions are first fetched into an Instruction-Register (IR) queue (aka an instruction buffer) using a dedicated instruction-bus, and then moved into an instruction pipeline to execute instructions. Data is first fetched into a load-buffer using a dedicated data-bus and then moved into a dedicated General-Purpose-Register (GPR) bank for computing. In a RISC ISA, there are fixed 32 GPRs per CPU, each GPR may be 32-bits, 64-bits, or 128-bits wide in modern super-scalar computers. Data transfer from L1$ to instruction and data buffers use a dedicated unidirectional I-bus for instructions & dedicated bidirectional D-bus for data. The CPU operates broadly within these storage-buffers (aka register buffer, load buffer, store buffer), and more finely withing Instruction-pipeline & GPRs, interpreting instructions from the IR-pipeline, and reading/writing data from/to GPRs respectively. Data written to a GPR is rippled thru L1$D-L2$-L3$ as needed to save (=store) a computational result. Coherency policies update all duplicated data copies during a data-store. During instruction execution, both instruction-bus and data-bus in the communication path gets utilized cyclically. However, in the event when the instruction-bus is not needed to feed new instructions (such as in the case of using an accelerator in a CPU pipeline & data-path), the bandwidth dedicated to move the instructions is wasted. It would be desirable to improve the efficiency of instruction bus utilization for instruction-accelerator compute work-loads. For accelerator computations within a CPU pipeline, it would be further desirable to increase the data bandwidth to sustain the high compute density in accelerators. Today, all CPUs use a separate co-processor with a dedicated memory for accelerator implementations, and data is copied from the CPU space to the co-processor space.

Hardware functions are circuit blocks, hard wired during manufacturing to perform specific functions, having one or more inputs, and generating one or more outputs in response to the inputs. In a single instruction multiple data (SIMD) variant of a microprocessor HWA, such as in GPUs, one instruction may select a plurality of identical pre-defined hardware functions to process multiple data inputs simultaneously. GPUs & co-processors support a very small instruction-set, far fewer than a general-purpose RISC CPU. Parallel processing improves compute performance. In CPUs & GPUs, the instructions & hardware blocks are pre-designed to allow control-signals to select the desired hardware structures. The control unit orchestrates the data flow without any data conflicts to ensure efficient and accurate instruction execution within the CPU pipeline stages. Control units generate control signals that select pre-defined hardware structures. General purpose compute CPUs have balanced instruction bandwidth and data bandwidth to optimize work-load execution. However, a SIMD-CPU would require fewer instructions compared to data in compute work-loads, causing an asymmetric bandwidth requirement over general purpose computing. As a result, general-purpose CPUs are not efficient in SIMD execution, and GPUs are designed to handle far better SIMD data bandwidth. A CPU HWA is balanced to orchestrate approximately equal instruction & data flow, while GPU HWA (note that GPUs need an external host-CPU to handle most of the generic instructions) is separately balanced to handle lighter SIMD instruction flow and much higher data flow. Co-processors are designed to handle data bandwidth from a separately dedicated memory space. Existing prior-art HWA are fixed bandwidth architectures: meaning the instruction path and data path is pre-designed to handle a defined compute mix in CPU execution & co-processor execution. It is desirable to move an accelerator unit inside of the CPU pipeline for heterogeneous & high-performance computing to avoid duplicated data-paths and data orchestration as it is cheaper, faster & consumes less power. If an Accelerator hardware unit is inside a CPU-pipeline, it must support CPU-workloads when the CPU is in use, and Accelerator workloads when the accelerator is in use, both efficiently within the same HWA. This requires a new HWA architecture that is configurable. The ˜50/50 balanced instruction/data loads in general-purpose computing drastically change to ˜1/99 condition when a Domain-Specific-Accelerator (DSA) is in use. This is the case for Large Language Models (LLMs) in AI, where multiply-accumulates dominate the compute work-loads. Thus when using both SIMD & Accelerator as examples, a dedicated instruction bandwidth is underutilized, and a dedicated data bandwidth is overutilized. Hybrid-Compute CPUs, comprising co-processors, would benefit from configurable bandwidth balancing to improve compute performance for HPC. Prior-art fixed HWAs do not allow this bandwidth balancing flexibility.

External memory communicates with on-chip memory utilizing on-chip input/output (I/O) pins. Communication standards such as USB, GPIO, PCIe, and DDR ensure compatibility in data transfer between chips. Data rates of standards improve over time, with each new generation adopted, both data transfer frequency and number of wires to transfer data increasing over time. Double data rate and quadruple data rate allows two and four bits of data to transfer in one clock cycle. A physical layer ensures good signal integrity, and an eye-diagram is used to evaluate signal separation with no-overlap in transitions between adjacent data. Chip I/O pins are limited as they scale with the chip perimeter. A chip may comprise one in-line, two staggered or three staggered rows of I/Os around the perimeter. These chip I/Os are wire-bonded or bumped and connected in a ball-grid array to a motherboard. Compared to transistor scaling over time, the wire-bond and ball-grid pitches do not scale as aggressively. Hence the number of I/Os is a major bottleneck to get more data into the chip. A new technology using thru-silicon-vias (TSV) allow better scaling in micro-bumps, and chip-to-chip wafer level bonding. High bandwidth memory (HBM) is one method of connecting a CPU and memory device using micro-bumps to a silicon interposer where data transfer wire dimensions match chip rules to improve bus wire density. Besides physical size & density limitations to I/O scaling, data compression and de-compression is another area of increasing bandwidth at the expense of extra computing. Power consumed by external I/Os is very high due to long (centimeters to meters) in lateral dimensions for chip-to-chip data transfer. Vertically bonded die reduces the distance and hence power. Different I/O protocols support different data transfer types. Network cards and graphics communication may use PCIe-7 offering 128 GT/s/pin, while memory data transfer may use DDR-7 offering 64 Gb/s/pin. In comparison HBM4 may offer 6.4 Gb/s/pin for memory data, as 2048 micro-bumps can be used to receive 1.6 TB/s of data. Stack-ability and the 2048-wide bus-width makes HBM4 bandwidth higher than DDR-6, at a high silicon-interposer added cost. For CPUs, both instructions and data consume the precious available I/O bandwidth. GPUs benefit by balancing fewer special GPU-instructions it needs with much higher data bandwidth to compute. In hybrid computing, even a GPU instruction is first received by the CPU, then diverted to the GPU to process the instruction. Passing instructions and data is cumbersome to the CPU as it must traverse the CPU compute space first. Modern GPUs may provide an external memory address to the GPU, but then it must fetch the data to its own dedicated memory space, compute and retire back to storage. While good at batch-mode processing large chunks of GPU code, there is no back-and-forth computing between host-CPU & slave-GPU. A GPU cannot update shared memory used by CPU that has data fetch and store under purview of the CPU cache coherency protocol, so it must stop the CPU (with an interrupt) update the shared memory and then allow the CPU to restart. Embedded co-processors do not have the I/O flexibility of GPUs, and must adhere to more stringent constraints to pass instructions and copy data. They may use a Direct Memory Access (DMA) to copy data from CPU memory space to co-processor memory space. When DMA accesses CPU memory, the CPU must be halted. A fixed co-processor L2 memory capacity significantly limits a co-processors compute capability to a burst-mode compute rate. As an example, an embedded 50 Tera-Operations per second (TOP/s) NPU must work with a dedicated L2-cache, typically ˜3 MB in size or greater. At 2 GHZ frequency, in 128-cycles, the NPU consumes the entire L2-cache capacity in Matrix Multiply Operations, and must wait to retire the results from L2-cache, and load new data to continue multiplying. This effort to write/store 3 MB L2 memory can consume 30,000-100,000 cycles while halting the CPU, degrading the NPU peak performance to an average ˜60-200 GOP/s. Improving the average performance, updating shared memory continuously, and not halting the CPUs in prior-art co-processors is highly desirable.

Instruction processing systems require the ISA to be tightly coupled to the chip HWA. Compilers map high-level SW code to Assembly Language, and assemblers convert assembly language into HW execution instructions with some inbuilt indirection. Fixed length RISC instructions lend to easy instruction decode and fixed bus-width HWA. Variable length CISC instructions create complex decode & bus-width in HWA. Post-synthesis code compaction is used in CISC ISA to identify RISC operands, justifying the need for both to co-exist to reduce code density. This division is difficult due to the pre-defined HWA bus structure. Every API can benefit from unique HW-block custom instructions, but having a HW-block super-set for general-purpose computing is not economical. A configurable-HW may be programmed by Firmware (FW) to execute a custom accelerator function. Thus configurable-HW does not need instructions as the instruction is programmed by FW to customize the HW-unit function. A configurable-HW unit may offer significant compute advantage in Hybrid-Compute CPUs, and these Accelerators may further benefit with high bandwidth data access to accelerator when instructions are not needed. However fixed HW in data-bus and cache-memory structures have a pre-defined data bandwidth that is not changeable between instructions and data. A configurable bandwidth in embedded co-processor systems is desirable. Input/Output (IO) device pad limitation is a major draw-back for data-bandwidth in chip scaling today. With RISC or CISC instructions, limited chip IO's must support both instruction-data and compute-data. More instructions reduce compute data & compute throughput. GPU's share a single instruction on multiple data (SIMD) using “identical” function-unit copies to enhance compute-bandwidth. High throughput over the last decade is credited for higher GPU/CPU ratios in HWA. GPUs are power-hungry, with very limited use-options, and require a host-CPU for general-purpose computing. Industry trends show a real need to lower instruction over-head, customize functional-units, use multiple-instruction-multiple-data (MIMD), improve performance, and reduce power. Repetitive instructions clog-up the data bandwidth arteries. When Accelerator functions are used in HPC, there is a natural reduction in compiled-instructions in an API compared to compute-data. The OS brings instructions & data from external storage by caching, and will naturally favor fetching more data-pages (for large computations) compared to instruction-pages when using accelerators in HPC. However, the L2$-L1$D fixed data bandwidth will remain identical for the accelerator, which is the same as for CPU-instructions. It is desirable to increase the data bandwidth when using an accelerator.

Tightly-coupled embedded-accelerators and co-processors demonstrate the need for “very-complex” function instructions to improve domain-specific API performance at lower power. ISA-extensions are commonly used to add co-processors. Cloud systems offer loosely-coupled board-level CPU/FPGA, & CPU/GPU chips in network cards with PCIe and DDR bus interfaces. Single chip CPUs with embedded FPGA-cores attempt to boost performance, but only if the user can re-partition the program & create a new FPGA Verilog code. It is impractical to re-design large software APIs. All of these heterogeneous compute techniques use control and status register (CSR) commands for data compute acceleration, in addition to needing a custom compiler to incorporate the accelerator. These solutions are poor at context-transfer, unable to pass heap and attack variables between heterogeneous compute domains, and do not fully exploit the potential of compute acceleration. There is a real need for easy to use, inter-operable, flexible function heterogeneous accelerators inside CPUs to improve performance & reduce power. When compute density increases, the data bandwidth becomes the bottleneck. Then memory structures and bus structures require HW architectural improvements that can provide high data bandwidth to sustain average (not just burst-rate) high compute thruput.

A field programmable gate array (FPGA) is a widely used second embodiment of a general-purpose programmable device in the IC industry. A programmable tile in an FPGA is constructed as an array of programmable blocks, programmable segmented interconnects, memory, digital signal processing (DSP) blocks, programmable switch-blocks and programmable routing-blocks. In an FPGA, there is a plurality of such tiles replicated with IO and other circuitry required to build the FPGA chip. Users customize the FPGA using a bit-stream generated by a software development kits (SDK) based on a user software application. Instructions are hard-coded into the FPGA as hardware connections by the Bit-Stream. FPGAs comprise segmented wire architectures, each wire transporting a data bit, the nets configured by the Bit-Stream to implement an RTL-synthesized netlist. The Bit-Stream ensures data execution accuracy by construction. Unlike CPUs, high level C++/Jave code cannot convert to executable instructions in FPGAs. FPGAs do not have an ISA, nor machine-instructions as seen in CPUs, nor control-units to navigate data flow for execution accuracy. A single application must be re-coded in Verilog or RTL, synthesized to a netlist, placed and routed inside FPGA HWA to meet timing. A bit-pattern, loaded once at boot-time, freezes the time-stamped application in the general-purpose FPGA. An ASIC-block can be viewed as a frozen bit-pattern FPGA. While instruction-data is eliminated by bit-pattern, unclogging the data artery, the FPGA cannot adapt to evolving software, nor execute multiple programs concurrently. Bit-configurable interconnects in FPGA HWAs are difficult to dynamically re-configure due to damaging driver contention power surges. FPGAs do not have a cache hierarchy. It uses direct memory access (DMA) techniques to fetch needed data from memory structures. FPGAs are ˜10× slower than CPUs in frequency, and has a data-flow that is in-order. CPU concepts such as stack & heap used by SW-coders do not exist in FPGAs. Software coding, ISA & HWA differences prevent pipeline-coupling of CPU & FPGA heterogeneous compute units. If one can overcome these barriers, code suited for CPU-instructions can use CPU-HW; and code suited for FPGAs can use FPGA-HW having a Software-ASIC connectivity to the APIs. It is clear FPGA-CPU architectures need to evolve. Control units and coherent cache memory subsystems need to evolve to accommodate heterogeneous computing. Techniques are needed to improve data bandwidth to accommodate high compute accelerators defined by Software-ASICs to prevent bottle-necks in HPC data-paths, and have flexibility of FPGAs that allow user customization of accelerators (i.e. DSA construction by firmware). Clearly flexible coherent memory structures, high bandwidth interconnects, uniquified CPU-accelerator execution techniques, shared memory for hybrid-compute without interrupting the CPU, reduced latency from duplicated memory copy, and high data-rate innovations will enable low-power supercomputing in high performance & heterogeneous computing, edge computing, embedded AI, and bigdata. Firmware updates will enable customization of CPU functions based on individual requirements. When power-performance-area (PPA) can improve 100×-1000× over prior-art GPUs & CPUs respectively, it will facilitate live-data based autogenic & intelligent generative AI and bigdata computing in the hyperconnected world to be more capable, accessible, affordable & eco-friendly.

### SUMMARY

Incorporated by reference disclosures describe unified CPU and Accelerator compute systems that dramatically improve power-performance-area (PPA) over prior art compute systems to make computing more capable, accessible, affordable & eco-friendly. High performance computing (HPC) is a balancing data throughput and compute density. When compute density is dramatically increased, the HPC bottleneck becomes data bandwidth. This disclosure describes various embodiments in data structures, including cache memory, data bus, configurable buffers, and segmented interconnect structures & control units for microprocessors, content-compute processors and embedded accelerator systems (collectively termed macroprocessor units) to overcome data bandwidth limitations. This is especially important in embedded accelerator HPC. Improving von-Neumann and Harvard type CPU architecture instruction pipeline bottlenecks, providing high bandwidth data access to hybrid CPU-Accelerator compute units will enable dramatically improved PPA (performance, power, area) metric in computing leading to better instructions per cycle (IPC), cost, compute density, flexibility, solution life-time (SLT), time-to-solution (TTS), non-recurring engineering (NRE) costs, case of use & compute throughput.

The term “macroprocessor” is also used to define a CPU system comprising tightly coupled software and hardware architectures that has the capabilities and features of a microprocessor, graphics processor, gate array, field programmable gate array, and application specific integrated circuit. A macroprocessor comprises a microprocessor with its associated ISA, and a pipelined coupled co-processor configurable by firmware (FW) to serve as a domain specific accelerator (DSA). The DSA comprises field programmable gate array (FPGA) techniques of implementing custom design through a bit-stream FW. A macroprocessor further comprises one or more of: memory units, registers, ALUs, FPUs, carry-logic units, shifters, configurable logic elements, configurable memory (CRAM), look-up table logic (LUT) blocks, comparators, multipliers, DSPs, Analog Circuits, clocks, PLLs, control status registers (CSR), configurable segmented interconnects, co-processors (such as a graphics processor, tensor processor, neural processor, etc), and ASICs. The ASIC may comprise specific custom functions, including hard-IP, soft-IP, compute in memory & programmable-IP. Memory may comprise any volatile or non-volatile memory element, including SRAM, flash, EEPROM, MRAM, eFuse, laser-fuse, DRAM and state-transition memory. Memory includes cache. Cache structures comprise storage elements, coherent memory infra-structure, drivers, read circuitry, and write-circuitry. Instructions and data are communicated (or interconnected) in wires and buses. Bus architectures may comprise bit-byte configurability, segmented interconnects, gated-clocks and latches. Improving cache access and data bus architecture is essential to improving data bandwidth. Memory & bus structure may further benefit by configurable means of dynamically altering instruction bandwidth and data bandwidth to improve computing. Segmented wires may comprise early signal detection elements, and configurable drivers and buffers to facilitate high bandwidth data flow. Memory structures and bus structures may use control unit programmable means to dynamically adjusting the bandwidth of instructions and data by time-sharing the available hardware resources. A segmented bus architectures may facilitate single data rate, double data rate and even quadruple data rates or higher data rates to improve data bandwidth. Segmented bus interconnect may further promote multiple parallel data transfer segments within a mesh structure, configurably isolated from each other, to improve data bandwidth. Wires and buses may be configurably selected to drive bidirectional data with tri-statable states to isolate segmented net branches. Latched data in segmented bus interconnect may offer significantly reduced wire delays by early detection and gated-clocking techniques, that are further amenable to local latches to pipeline dataflow. A macroprocessor comprises a “data-pump” mode wherein the instruction bus is fully or partially allocated for data & QDR data pumping is used to significantly increase compute data based when accelerators (DSAs) dominate the work-loads during HPC.

A cache memory structure may comprise a sense-amplifier having a low-capacitance input node. A typical memory array comprises a plurality of word lines and bit lines. Address selected word line couple memory elements along the word line to each of the bit lines. In SRAM cache, the SRAM bit discharges a pre-charged bit line voltage to one of two levels: high power level, or a low trip voltage level. The time taken to stabilize the bit line includes a bit line settling time determined by RC-time constant (R=BL resistance, C=BL capacitance). For long metal lines, this is very large. In 3 nm platform, metal bit line R˜15 Ω/μm, and C˜0.2 fF/μm, and BL RC-time constant ˜3 fSec/μm. For 200 μm long bit line, the RC-time constant ˜1.2 nSec. Including address decode and word line rise time, we may need ˜2 nSec to get stable data in bit lines, leading to ˜500 MHz in memory operating clock rates. In comparison, best in class CPUs operate at ˜5 GHz. When a word line is selected, all bit lines settle to the end voltage level at the same time (memory clock rate). In comparison, a sense amplifier (SA) circuit to detect the bit line voltage may comprise an input node with much lower capacitance and an equivalent resistance. The wire length at a SA input node is ˜10 μm, and an equivalent SA RC-time constant ˜1000-10,000 times smaller at ˜10-100 pSec. In a first embodiment, multiple BLs in an address selected memory array is sensed sequentially to increase the cache data rates. BLs are arranged to sequence words (a word is equal to a cache line). They have the same lower address bits in big endian bit nomenclature, and only differ in an MSB-bit addressing. This 1-MSB bit can sequence 2-bits in adjacent words; and 2-MSB bits can sequence 4-bits in adjacent words to be evaluated in 1 memory clock cycle, facilitating single data rate (SDR), double data rate (DDR) & quadruple data rate (QDR) modes of data transfer. The SA output may be latched. A latch may act as a data buffer: to store a DDR or QDR SA data capture rate, but transfer the data in a plurality of data buses at a lower data rate. In a second embodiment, in a Harvard architecture CPU system, the instruction bus and data bus (of near equal bus widths) are allocated to only transfer data. This is feasible during repeated computing loops in an Accelerator as no instructions are needed during that time. SA SDR data capture facilitates DDR data transfer of two words from the cache array simultaneously in the two buses. If the SA comprised 2-latches, it facilitates SA DDR data capture, and QDR data transfer (two paired words serially) provided the bus delay can handle the fast data transfer speed. This technique is scalable: a single bus can be used to transfer data at SDR, DDR & QDR data rates, provided the wire-delays are amenable to data transfer rates. A first goal is to use a single bus structure, and increase the data bandwidth by clocking the SA circuit to read multiple words, and serially transfer data at a 2×, 4× or 8× higher clock rate compared to a memory access clock rate. A second goal is to borrow the instruction bus to transfer data, and use two bus structures, and increase the data bandwidth by clocking the SA circuit to read multiple words: serially transferring two data words in parallel at 2×, 4× and 8× higher clock rate compared to a memory access clock rate. A cache memory facilitates sense circuit by-pass and configurable access to a plurality of bit lines to write multiple words in parallel to a cache memory structure.

When memory access and data detect rates improve, the bus wire delay becomes the limiting factor to data transfer rate. To improve wire delays, a segmented bus interconnect structure is proposed. Recognizing that a bus comprises a metal wire, and wire delay scales with L2, where L is the length of the wire, a segmented interconnect allows to design a wire length to meet a suitable wire delay that can sustain a high data rate. The segmented wires allow configurability adjusting a tri-state capability, bi-directional buffering and clocked latching to improve signal integrity of data transfer wire segments. A third goal is to provide a programmable segmented interconnect structure, wherein each wire segment will maintain the data rate set by the driver clock rate in a memory structure, and relay a buffered signal to the next wire segment to achieve very high data bandwidth in interconnect structures. A fourth goal is to isolate a plurality of data transfer nets from each other, so that in parallel multiple nets can communicate data to further improve data bandwidth. In accordance with this net isolation, while an L3 memory communicates with a first L2 memory, a second and third L2 memory structure may communicate with each other utilizing the same wire mesh.

This invention will be more fully understood in conjunction with the following detailed description taken together with the drawings.

### BRIEF DESCRIPTION OF THE DRAWINGS

FIG. 1A shows a prior art computer processor unit (CPU) architecture.

FIG. 1B shows a prior art 3-level cache memory hierarchy of a multi-core CPU SOC.

FIG. 1C shows a detailed view a prior art cache memory block comprised of two address levels.

FIG. 1D shows a prior art set associative cache structure used with addressing and tag matching.

FIG. 2A shows a prior art von-Neumann architecture microprocessor.

FIG. 2B shows a prior art Harvard architecture microprocessor with separate instruction & data bus.

FIG. 2C shows a related art in generated compiled code and loop activity associated with 1024 repeated instruction execution for multiply-accumulate & floating-point accumulate.

FIG. 3A shows a first embodiment of a high bandwidth memory structure comprising configurable data bus access modes in cache memories.

FIG. 3B shows another embodiment of a high bandwidth memory structure comprising configurable data bus access modes in cache memories.

FIG. 3C shows a double-clocked sensing DDR-mode to increase memory bandwidth in high bandwidth cache memory structures.

FIG. 4A shows a detailed view of the double-clocked sensing DDR-mode utilized in FIG. 3C.

FIG. 4B shows a timing diagram for double data rate (DDR) sensing in FIG. 4A sense scheme.

FIG. 4C shows a signal diagram for double data rate (DDR) sensing in FIG. 4A sense scheme utilizing a 2× clock signal.

FIG. 4D shows a signal diagram for double data rate (DDR) data capture in two latches for FIG. 4C.

FIG. 4E shows a signal diagram for quadruple data rate (QDR) sensing in FIG. 4A sense scheme utilizing a 4× clock signal.

FIG. 4F shows a signal diagram for quadruple data rate (QDR) data capture in 4 latches for FIG. 4E.

FIG. 4G shows a signal diagram of an embodiment for quadruple data rate (QDR) data capture in 4 latches using an 8× clock to transfer 4× data in one clock cycle for FIG. 4A.

FIG. 5A shows a first embodiment of a novel pipelined accelerator high bandwidth macroprocessor.

FIG. 5B shows a second embodiment of a novel pipelined accelerator high bandwidth macroprocessor.

FIG. 6A shows a novel set-associative cache structure to improve data access and transfer.

FIG. 6B shows a configurable buffer for bidirectional data transfer in a segmented bus.

FIG. 6C shows a configurable tristate latch buffer for bidirectional data transfer in a segmented bus.

FIG. 6D shows a signal diagram for edge-triggered 4× bandwidth data transfer in a segmented bus.

FIG. 6E shows a configurable segmented bus architecture for cache memory interconnect mesh.

FIG. 6F shows a configurable switch for use at bus-crosspoints to selectively buffer and drive bidirectional data in a segmented bus architecture.

FIG. 6G shows a voltage transfer curves for early input transition detector circuit comprising dual V_{TL} & V_{TH} trip point inverters.

FIG. 7A shows a novel high bandwidth macroprocessor micro-architecture comprising a coherent cache memory hierarchy.

### DETAILED DESCRIPTION

In the following detailed description of the invention, reference is made to the accompanying drawings which form a part hereof, and in which is shown, by way of illustration, specific embodiments in which the invention may be practiced. These embodiments are described in sufficient detail to enable those skilled in the art to practice the invention. Other embodiments may be utilized and structural, logical, and electrical changes may be made without departing from the scope of the present invention.

The terms microprocessor and computer processing unit (CPU) used in the following description include any structure that can receive instructions and data, execute an operation, generate a result, and store that result. The structure comprises electronic circuits in an integrated circuit (IC) device. The structure is understood to include memory, control-units, decode circuitry, memory-tags, storage buffers, memory management units, cache structures, registers and other electronic circuits that are used to construct CPUs. The term pipeline is used to refer to the various structures in all of the stages required to process an instruction; from the time it is fetched from a memory location (such as instruction-cache) to the time it is retired after completing the instruction after writing results back into memory (data cache) if needed. It is understood that a plurality of instructions may be fetched in a super-scalar CPU, and a pipeline may have parallel branches to simultaneously execute multiple instructions. A pipeline may have in-order and out-of-order instruction execution capabilities, and for the later, additional structures required to ensure data integrity. The term thread is used to refer to a plurality of compiled instructions in a work-load that is generated from a user created software program during compile-time that comprise data dependency and an instruction-order that ensures execution accuracy. A compiled instruction is a hardware micro instruction that is executed in one or more cycles in pre-defined hardware structures.

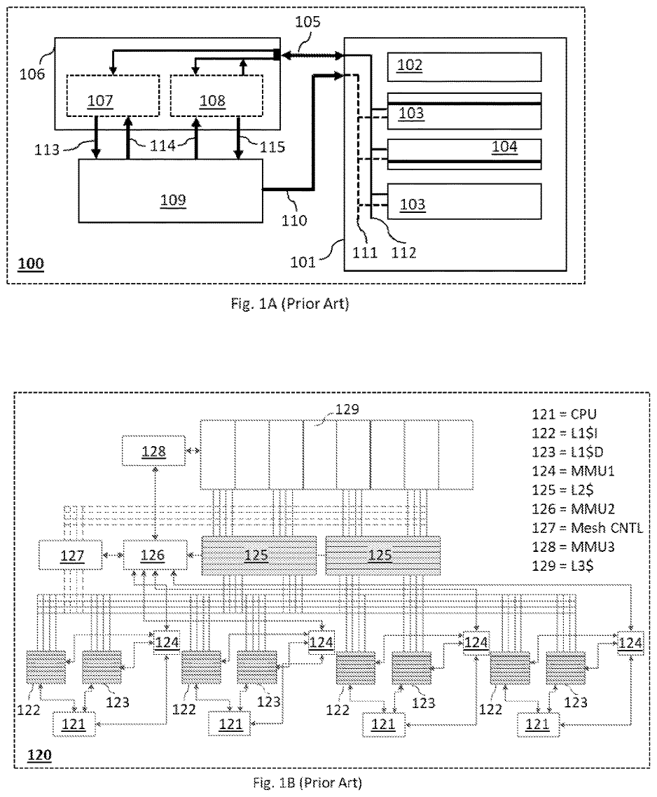

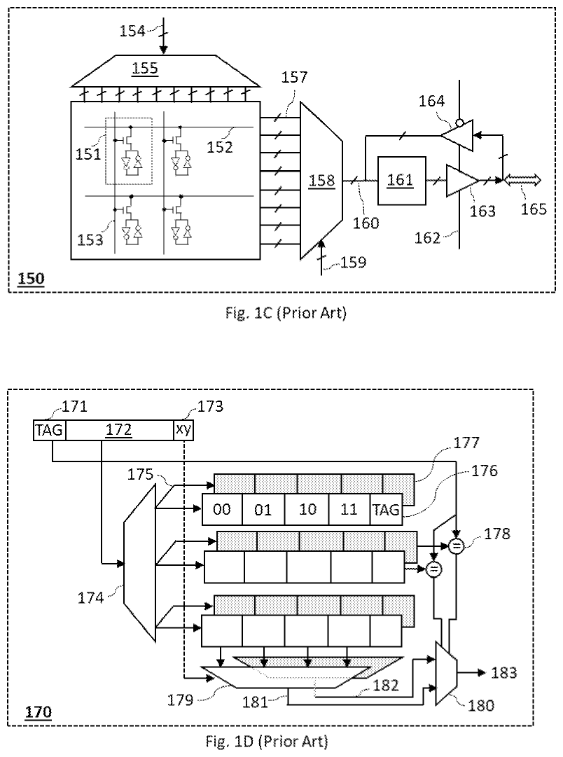

A CPU, or central processing unit, is typically the key element in a large silicon integrated circuit today. Ref-1, Ref-2 & Ref-3 provide an overview of computer architectures given in a series of lectures by David Murray, in Oxford University. All microprocessors follow Von Neumann data-path control-path architecture, or a modified Harvard architecture that split data-path into separate instruction-path and data-path. An exemplary prior art microprocessor 100 is shown in FIG. 1A. Microprocessor data is classified into two groups: (i) instruction data, telling the computer what to do and (ii) compute data, the information it needs to process at each instruction. An external memory unit 101, such as a Solid-State Drive (SSD), stores all the data. In memory 101, computer boot code may be stored in a region 102, compute data may be stored in a plurality of regions 103, and program instruction data may be stored in a region 104. Memory unit 101 has inbuilt control bus 111 to select a memory address, an inbuilt data bus 112 to retrieve/supply data during read/write from/to the memory address. Inbuilt logic in 101 (not shown) complete read/write memory functions based on control signal 111 information. In Von Neumann & Harvard architectures, CPU 100 comprises a data unit 106 and a control unit 109. Memory 101 couples to data unit 106 via bus 105, and to control unit 109 via bus 110. Data unit 106 may further comprise an instruction-register (I-cache) unit 107, and a compute-data (D-cache) unit 108. In Harvard architectures, they use independent data buses. Control unit 109 generates all hardware signals (level signals, pulse signals, hard-ware control signals, data transfers, etc.) to ensure execution accuracy. Control unit 109 receives instructions from I-cache 107 via data path 113; and it generates control signals 114 to keep I-cache & D-cache synchronized using data flags on 115. It also ensures continuity of instructions. Control unit 109 may respond to external controls (not shown, such as those generated by operating system or a thermal management system).

A significant breakthrough in Harvard-like architecture is that control section 107/109 is separated from data section 108/109. Hardware pre-defined micro-instructions dictate the required control signals for every operational clock cycle to operate hardware. Changing control signals 114 manage data movement from a memory read through execution units back into a memory storage. This is the basis for all CPUs that are in existence over the last 60-years. The downside is, since micro-instructions change every clock-cycle, control signals must also change every clock cycle to accommodate the cyclical instruction execution. Moving the same instruction multiple times leads to performance & throughput penalty with wasted power. It is desirable to improve performance and power in CPUs by augmenting Harvard architectures.

A CPU utilizes a structure of memory in a hierarchy intended to limit the latency of moving both instructions and data into and out of the CPU. To complicate this, more than one processing unit exists today in nearly every microprocessor that is in production. In addition, the memory is shared between the CPUs until the cache hierarchy reaches the lowest level in the structure and thus, the lowest level memory (L0 or L1) is typically a dedicated structure to that last CPU in the hierarchy. An example of this hierarchy is shown in 120 of FIG. 1B for 4-core processor system (aka a 4-way CPU SoC).

In FIG. 1B, three cache memory levels are shown to illustrate caching memory hierarchy. Upper most third level is L3-cache (L3$) 129, and the next second level is L2-cache (L2$) 125. The four CPUs 121 are at the end of the memory hierarchy. When the information reaches the lowest level of Cache (L1$), the memory is normally split into two different structures; one for instructions called the instruction-cache (L1$I) 122 and one for data called the data-cache (L1$D) 123. Each CPU has its own L1$I & L1$D caches. A dedicated memory management unit (MMU) 124 manage data transactions between a ubique CPU 121 and its dedicated L1 caches (122, 123). Instruction registers (not shown) and data registers (not shown) inside the CPU receive data transactions from L1$I 122 and L1$D 123 respectively. The next higher-level cache L2$ 125, is typically managed by a separate MMU 126 and is normally treated as one large virtual memory space. A single L2$ 125 feeds into a plurality of CPUs L1-caches via dedicated Load/Store units (not shown). A central L3$ to a plurality of L2$ cache connectivity is managed in a mesh system utilizing a mesh controller 127 so that data transfer occurs in succession. Finally, the highest-level L3$ 129 is typically connected to an outside Chip memory system through an IO management system 128 either directly or indirectly to bring in the data from the external memory such as a Hard-Drive.

In today's processor, because the amount of instruction and data bits are approximately the same for most general-purpose code. It is essential for efficiency and performance that the busses are separated between them and the bus-widths are balanced to match instruction thruput and data thruput. When both bit-densities are similar, bus-widths are chosen to be the same (for example, say from L2$ 125 to L1$I 122, and from L2$ 125 to L1$D 123 in FIG. 1B). The reason for two busses is that if both data and instructions were on the same bus, there would be a contention in getting either one or the other sets into the processor pipeline during any particular cycle. This was the case reason for Havard Architectural innovation in the Von Neumann architecture of the original CPU. The standard today is to use two separate buses for moving both data and instructions simultaneously into the CPU. For example, while instructions are being fetched and decoded from L1$I 122, a separate Load/Store unit (not shown) can access memory L1$D 123 and bring in the data to be processed so that the CPU pipeline can continue on sequentially and process it without having to stall the pipeline and wait for the data to be placed into the proper location for execution. This results in a much more efficient use of resources allowing the CPU to perform at a nearly optimal rate.

A prior art memory structure used in L3$ 129 and L2$ 125 is shown in 150 of FIG. 1C. It comprises a plurality of row-lines (aka word-lines) 153 and a plurality of column-lines (aka bit-line). At each intersection of the two, there exists a storage element such as 151. A simplified 5T-SRAM cell is shown in 151 to illustrate the memory operation. A read operation is discussed first. When a word-line 153 is assessed, the corresponding bit-cell 151 output is obtained in bit-line 152. Using a row-address bus 154, and a row-decoder multiplexer 155, the row-address in 154 selects one of the plurality of row-lines 153 in the memory array, and all corresponding bit-cell data in that row-line is outputted into the plurality of parallel bit-lines 152. Each output bus 157 shown is a grouped bundle of output wires. For example, one 157 bus may be eight (or four, or sixteen) column-lines such as 152 represented as one bus. Part of addressing includes a column-address (aka io-mux address) 159. IO-mux 158 selects one of the buses 157 to couple to mux output bus 160, which is coupled to a sensing device (such as a sense-amplifier) 161 to read the data values in bit-cells. An output buffer 163 receives the read-data, and use drivers to transmit the data to its destination using a bi-directional bus 165. During a write operation, data is received in the bi-directional BUS 165 that must be stored in the bit-cells 151 in the array. A write-enable signal 162 selects if the operation is read or write; enabling output buffer 162 for a read operation, and enabling input buffer 164 for a write operation. Sense device 161 is by-passed during write, and the address-decode mechanism selects one group of bus lines 157 to couple to data-bus 165. Bit-cells 151 at the intersection of 8-column lines 152 and selected row-line 153 gets updated by the write-values in the bus 165. For a memory that is used as a read-only memory, the input-buffer 164 coupled to a unidirectional bus 165 is unnecessary as the memory bit-cells 151 is never updated by the bus 165 data.

Typically, lower-level smaller L1$I and L1$D caches are designed with a slight modification to 150 in FIG. 1C. A prior art example of set-associative cache L1$D 170 is shown in FIG. 1D to illustrate a cache structure that stores only a small fraction of the external data (or even L2$ data) in it. The cache address comprises three fields: tag field 171, cache decode field 172 and off-set (aka io-mux) field 173. Decoder 174 decodes address 172 to select the desired word-line 175. In 170, two memory arrays 176 and 177 are shown, one behind the other. Both share the common word-lines 175 selected by address-bits. A single word-line spans the array-in 170, it spans four bytes 00, 01, 10 & 11. Word-lines may span four words, or 16-bytes, each word being 4 bytes. A word-line span is termed a cache-line. In 170, the cache line is 4-bytes. It is more common to have a cache-line that is 4-words, or 16-bytes (0000, 0001, . . . , 1111). The off-set bits xy in field 173 selects one of the four groups selected by word-line 175 via io-MUX 179. Memory-copies 176 & 177 provide outputs 181 and a82 respectively. In addition to data, a TAG field is also stored in 176 & 177 memories, which is read while reading the selected word-line 175. The data TAG is compared with address-TAG 171 in comparator logic 178. TAG matching output of 181 or 182 is selected in MUX 180 to provide requested cache data in output 183. The sensing (not shown) may be done pre or post MUX 179. The goal of L1$ is to get the data faster. As an example, access ties in caches may be L1$˜300 pS, L2$˜2 nS, L3$˜50 nS, external-drives ˜1 mS.

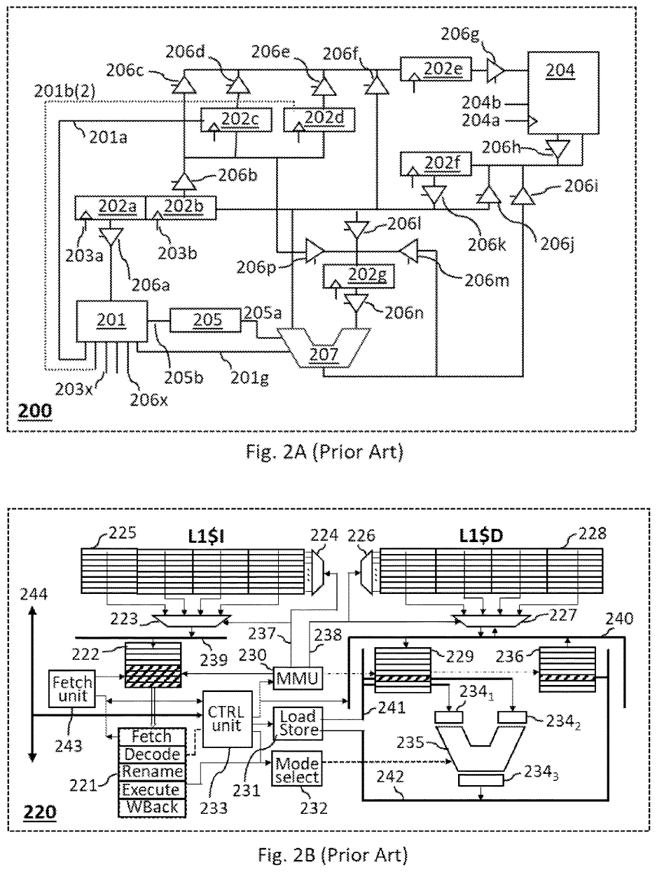

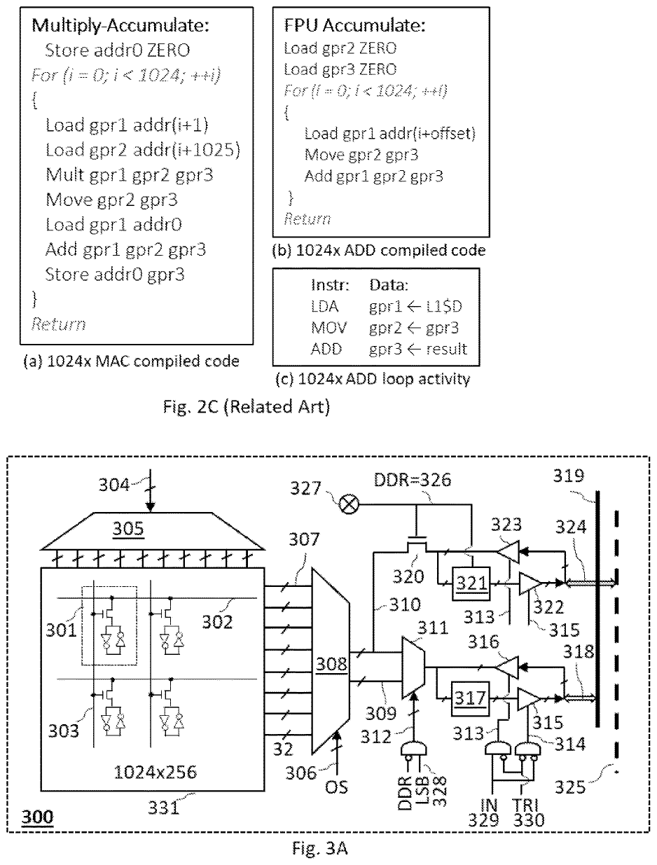

A prior art von-Neumann architecture microprocessor 200 having tri-statable driver register-ports is shown in FIG. 2A. The microprocessor 200 comprises a control unit 201, memory unit 204, a plurality of registers (each a register-port) 202, a hardware-unit such as an arithmetic-logic unit (ALU) 207, and a plurality of tri-statable drivers 206. For diagram clarity, logic associated with the registers 202 and gated clock-signals for drivers 206 are not shown: they are simply lumped into a single label. For this simplified microprocessor illustration, the registers are: 202a=instruction OPCODE register, 202b=instruction ADDRESS register, 202c=program counter register, 202d=stack pointer register, 202c=memory address register, 202f=memory data register, and 202g=ALU accumulator register. Each of the register-ports 202x receives a gated clock control pulse signal (CPS 203 followed by a letter) 203x generated by control unit 201. Program counter 202c receives a load (=0) or increment (=1) control level signal (CLS 201 followed by a letter) signal 201a and CPS 203c (not shown) signal. Stack pointer 202c receives a two-bit CLS signals 201_b0/b1 (1×=load from bus, 01=increment, 00=decrement) on CPS 203d (not shown) signal. Memory unit 204 receives memory read (=0)/write (=1) CLS 204b and CPS 204a. ALU 207 provides status tags via 205a to status register 205, the output of which is coupled to control unit 201 to determine in-use or availability of ALU. Each of the tri-statable drivers (206 followed by a letter) 206x comprises a CLS output enable signal, also designated by same label 206x. When enabled, the input of driver is coupled to its output, when dis-abled, the driver is tri-stated. Each driver couples a plurality of input wires to a plurality of output wires, typically the bus-width. For a 32-bit processor, this may be 32-wires or bits. The directionality of the driver sets the direction of data-flow. For instructions, IR 202a to 201 (coupled to instruction decode not shown) coupling bus is unidirectional by driver 206a. For data, memory 204 to ALU 207 is bidirectional: driver 206h to read data from memory via staged registers and drivers, and driver 206j to write results back to memory. The control-unit 201 generates the CLS and CPS at every clock cycle as described in FIG. 1B of incorporated by reference “Control Units for Heterogeneous Compute Processors”. These signals are associated with instructions defined by Instruction Set Architecture (ISA) of the microprocessor, and the no-conflict signals are compiled into a look-up-table upon compilation of the micro-instructions. In 200, both instructions into IR 202a/b and data into ALU 207 share a common bus, and general-purpose registers and cache memories are absent for simplicity.

As previously stated, in Harvard architectures, both instructions and data are fetched concurrently for efficient use of hardware resources for optimal CPU performance from lower cache levels. In an ISA, only pre-defined instructions can manipulate data, meaning if one needs to add two numbers, it is the “add” command in the instruction-decode pipeline stage that assign the control-unit to fetch the two numbers to an FPU for addition. If there are 1024 consecutive additions, there needs to be 1024 consecutive add-instructions, each add instruction preceded by two data-load instructions and succeeded by one data store instruction. There is a relatively close balance in the amounts of instruction-data and compute-data fetched from cache memory, and the HW dedicated to this method is efficiently utilize. However, it is a real waste of energy and bandwidth to specify a “selected-add” unit to repeatedly set it up to add, again and again 1024 times (even though there is no mechanism in CPU-ISA to not do so). The data-load (read from L1$D) and data-store (write to L1$D) commands operate between general-purpose registers & L1$D to improve the instruction execution efficiency, and LOAD/STORE commands also utilize instruction pipeline DECODE stage to instruct control-unit to engage L/S-unit & MMU to transfer required data. Hypothetically, if that activity can also be transferred to some alternative data load-store technique (such as a direct memory access DMA), the entire 1024-consecutive additions in our example would have no instructions; instead, the FPU-add HW could be executed serially by feeding data from the memory-unit, and writing back results to the memory-unit. Such a technique is disclosed in incorporated-by-reference application “Control Units for Heterogeneous Compute Processors”. In that disclosure, a slave-control unit in a Flexible-Accelerator HW can take over data fetch and data store requirement using a DMA for the 1024 consecutive add-functions. When instructions are altogether eliminated, or significantly eliminated by Accelerator features, there is a large imbalance between the number of instructions (as low as zero) and the amount of data (the maximin data bandwidth would allow) in transferred bits (or kB, or pages). Fixed bandwidth HW resources dedicated for I-cache & D-cache become much less efficient, and an alternative bandwidth balancing or sharing is more beneficial.

An example of a prior art Harvard architecture CPU coupled to L1-cache is shown in 220 of FIG. 2B. Operating system (OS) assigns a work-load thread to CPU 220, by using a systems bus 244 and using control status registers and program registers in control unit 233. CPU 220 comprises a fetch-unit 243 that can receive a program start address from control unit 233, to use an address pointer into a hierarchy of instructions storage locations, starting at instruction buffer 222, from where the instructions must be fetched. Upon “near” completion of existing work-load, control unit 233 may communicate back to the OS that it is ready for the next work-load. Fetch unit has an address increment feature that continues to bring instructions until the thread is processed. A fetch policy may determine dead-time for a new thread, to signal the OS that CPU 220 is near completion of assigned work to receive the next thread before the previous thread is completed to reduce/eliminate idle-time. The address pointer request ripples through the instruction-hierarchy with cache-misses until the required instructions are fetched into L1$I and instruction-buffer 222. CPU 220 may continue to run the previous thread during this idle time. Similar to instructions, a data-call will also ripple thru the data cache hierarchy, starting at load-buffer 229, with cache-misses until the required data is available at L1$D and load-buffer 229. CPU 220 further comprises a L1$I 225 and L1$D 228, both assumed to be set-associative cache structures as shown in FIG. 1D (address Tags are not shown). L1$I 225 comprise a row-address MUX 224 & IO-Mux 223 (aka bit-offset MUX). L1$D 228 comprise a row-address MUX 226 & IO-Mux 227 (aka bit-offset MUX). Address selection is handled by memory management unit (MMU) 230 for both via address bus 237 (for I$) and 238 (for D$). MMU 230 is coupled to control unit 233 that coordinates data transfers to and from L1-caches. Control unit 233 transfers data in chunks of cache-line, which may be 4-bytes=32 b wide, or 8-bytes=64 b wide as defined by HWA. Bus 239 facilitates instruction “read” transfers from L1$I 225 to an instruction buffer 222; while bus 240 facilitates data “read” transfer from L1$D 228 to a data load buffer 229. Bus 240 also couples a data store buffer 236 to L1$D to facilitate data “write” transfers. The control unit 233 manages all data transfers between buffers and caches with the MMU 230 assisting in address generation for all caches (source/sink) and buffers (sink/source). Instructions in I-buffer 222 may be arranged in FIFO order, and in-order they are fetched into the instruction pipeline 221 of the CPU, which is shown as a 5-stage pipeline. In a super-scalar, 4-consecutive instructions may be fetched into 4-pipelines in parallel, decoded and renamed simultaneously. For simplicity, we will focus on a single pipeline scalar CPU. The decode stage of 221 carries information to control unit 233 on entire data-flow orchestration required to execute the instruction: how and when to engage MMU 230, Load/Store unit 231 and Mode-Select 232, which selects the execution unit 235 functionality from a plurality of ISA-defined function choices. As an example, assume execution unit 235 is a floating-point unit (FPU)—then 232 selects if it is an add, multiply, divide, etc. Control unit 232 has to synchronize the function mode selection with the exact cycle of the operand arrival 234₁ & 234₂ to execution unit. A load unit 231, in unison with control unit 233 move operands from load-buffer 229 to general-purpose-register inputs 234₁ & 234₂ designated to the FPU 235 utilizing load network 241. The FPU may take 1 or more cycles to complete the function: a divide could take up to 10-cycles to complete. The output of the FPU is coupled to general-purpose-register 234₃, and a valid result is available after the pre-determined cycles are complete. A store-unit 231 writes the result into a store-buffer 236 utilizing store network 242 during the write-back stage in the pipeline 221. When the store buffer 236 has a block of completed data, the control unit 233 writes the data back into L1$D on data-bus 240 with the MMU 230 specifying address location on address-bus 238. Data flow in bus 240 is bi-directional, loading the data into load buffer 229, and storing data from store-buffer 236. Entire CPU operation is governed by an instruction in the decode unit of 221. Instruction band-width and data-bandwidth is approximately balanced as the cache-lines have similar bit-width. For every ISA-instruction in the decode stage, the control unit has an exact pre-define operational pattern it must execute, which can be represented in a finite-state machine. As a result, even if there are 1024 adds for an FPU-it must repeatedly send load, add & store instructions. There is no mechanism in CPUs to remove or simplify the messaging required for a CPU to operate in continuous mode. Since an execution HW consume only ˜10% of total energy of a compute, majority 90% of energy wasted is consumed by moving instructions down the instruction pipeline.

Repetitive multiply-accumulate (MAC) and addition (ADD) compute examples are illustrated in FIG. 2C. In the 1024 consecutive MAC operations (ops) code shown in (a), and 1024 consecutive ADD ops in (b), the for-loop is shown in C-code for simplicity, but the MAC & ADD codes are shown in compiled ISA-instructions. For the MAC in (a), 7 instructions are repeated 1024 times to get the result of a vector operation Ā·B̅, operands Aⱼ and Bⱼ fetched from L1$D and the ensuing result ΣAⱼBⱼ stored back to address_0 after each incremental j^{th} multiply. For the ΣAⱼ ADD in (b), 3 instructions are repeated 1024 times to get the result of scalar addition, operand Aⱼ fetched from L1$D and the ensuing result ΣAⱼ kept in a local gpr3 register after each incremental j^{th} addition. The looping 3-instructions for the ADD is shown in (c), where Aⱼ is fetched from L1$D to gpr1 in FPU, partial sum is moved to gpr2 in FPU from gpr3, and the partial addition result is written to gpr3. In existing CPU architectures, these nested instructions have to be repeated, which leads to unnecessary code increase, more code storage memory cost, wasted IO-bandwidth, more power, and less data compute thruput. Incorporated by reference disclosures describe a novel CPU that creates an accelerator function in repeated code blocks, and further describe eliminating or reducing code-density for accelerator instructions to improve code storage memory cost, improved IO-bandwidth for data, less power, and high data compute thruput.

To further illustrate the overhead, consider the 1024 MAC math operation, a very common vector operation in AI large language models (LLM). The 7-steps in FIG. 2C (a) are repeated 1024 times (load, load, multiply, move, load, add, store) sequentially. Let's consider the following number of cycles for each instruction: load=3, multiply=6, move=1, add=3, store=2. Then 1-MAC consumes 21 cycles, generating 21 pairs of CLS/CPS signals in the 7 micro-operations of the MAC sequence. This sequence is traversed 1024 times. That amounts to 21k logic operations for the 1024 MACs. Clocking signals all the time repeatedly, even when a sequence of instructions does not change, consumes power. Sequencer power, logic power and clock power all add up. In general, the control unit 233 in FIG. 2B influence the following:
functional unit controls
program counter controls
stack-pointer controls
interrupt controls
scratchpad controls
address controls
and other control features.

It engages fetch-units and load/store units. It is desirable to reduce the 21k logic operations in a CPU when blocks of instructions are repeated.

Although the illustrations of prior art are to provide a background to demonstrate some of the disadvantages, it is to be understood that the areas for improvements needed are not limited to these precise disadvantages shown. One skilled in the art may describe other embodiment and modifications in prior art that warrant improvements to process Big-Data, High-Performance-Computing & AI-computing more effectively, cheaper, faster, at lower power, cyclically, customizable, SW coder accessible, using existing SW tools, provide data & model parallelism, sequential, improve instruction efficiency & improve IPC. Various embodiments of the invention are discussed next.

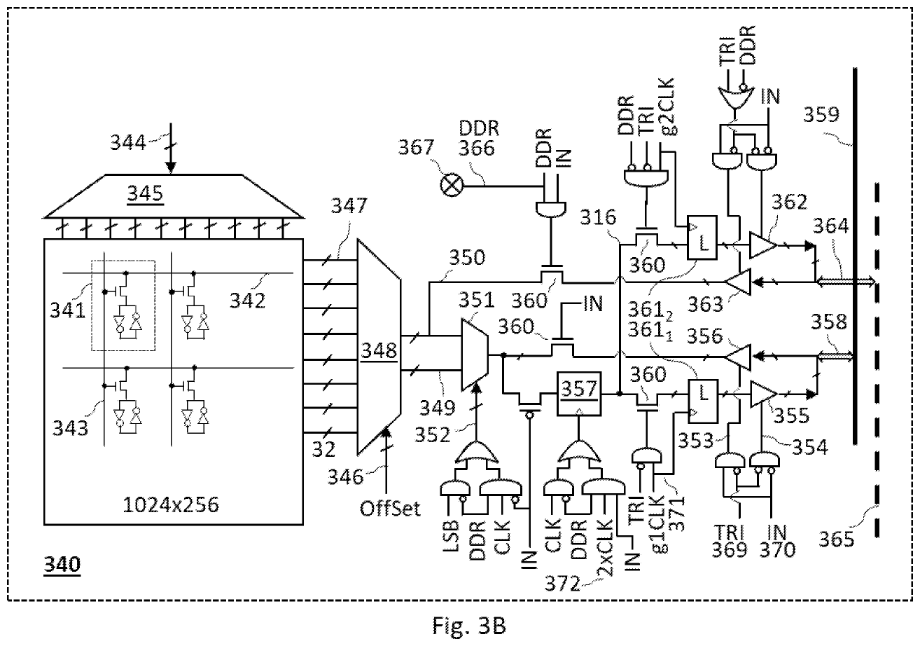

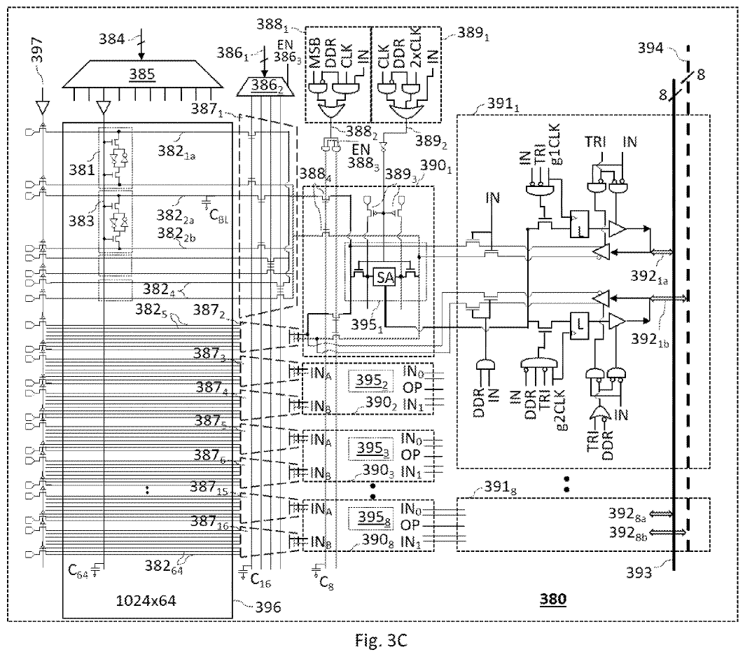

An embodiment for high band width memory data is shown in 300 of FIG. 3A. It comprises two modes of operation; a first single data rate (SDR) mode in which a word of data is read or written to memory, and a second double date rate (DDR) mode in which 2-words are read or written into memory. A word may be one or more bytes, a byte being 8-bits, and it is typical for a word to comprise 4-bytes. A word may be 8-bytes or 16-bytes, and may sometimes be called a double-word. Memory unit 300 comprises a memory cell array 331 comprised of a plurality of individual memory cells 301, each cell 301 storing a data-bit. A 5T SRAM cell is shown in 301 whereas a 6T-cell is the more commonly used. There may be 1 Mb or 1 Gb of memory cells in array 331, each memory cell located at an intersection of a word-line (WL) 303 and a bit-line (BL) 302. In FIG. 3A illustration, 1024 single WLs 303 and 256 single BLs 302 are shown; there may be multiple WLs & BLs per bit-cell 301 such as when using 6T or 8T SRAM cells. A row address decoder 305 receives a first portion of address-bits 304 to select a specific WL 303; and an IO-Mux address decoder 308 receives a second portion of address-bits 306 (aka offset bits) to select a subset of all the bits (inputs 307) in a selected WL. For simplicity wires are shown in multi-bit buses. In prior art, IO-Mux 227 in FIG. 2B receives lower order off-set address-bits to select a word from L1$D 228. We will use the term cache-line to represent the width of data selected by the FIG. 2B IO-Mux. In IO-Mux 308 of FIG. 3A, the offset bits in address 306 does not have at least the most significant bit (MSB), so the output of IO-Mux 308 comprises two cache-lines 309 & 310 (when one MSB bit is missing). If two MSBs are absent in address 306, IO-Mux output would become 4-cache-lines. The address-bits in OS 306 are chosen to facilitate more than a single cache-line as outputs of Mux 308. The circuitry to the right of Mux 308 represents the read-ports & write-ports of memory unit 300. It comprises a double data rate (DDR) mode select 326, which may be a control signal or a configurable memory-element 327. When DDR=1, the dual-word DDR-mode is selected; when DDR=0, the SDR mode is selected. This concept can be scaled to select quadruple-word data rate if needed. The Read/Write circuitry comprises a tri-state mode (TRI 330=1), write input mode (TRI=0, IN 329=1), and a read output mode (TRI=0, IN=0). During single-data DDR=0 (SDR) mode, all the data-bits are read and written using a single bus 319 via port 318. For a cache-line of 4-bytes=32 b, there are 32-wires in bus 319. During double-data DDR=1 mode, the first data bits in cache-line 309 are read and written using a first bus 319; and the second data bits in cache line 310 is read and written using a second bus 325 via port 324 concurrently with said first bus 319. This allows twice the band-width in data to transfer from the memory unit 300. An MSB-Mux 311 select the cache-lines between 309 and 310 for the SDR mode (DDR=0). The control-signal 312 to MSB-Mux 311 is generated by a logic function comprising DDR-mode and LSB-bit 328. When DDR=1 (always DDR), address 312 is set to “0” to always select data cache-line 309 by MSB-Mux 311 (decode mode is by-passed). When DDR-0 (in SDR mode), address 312 is determined by LSB status, selecting cache-line 309 when LSB-0, and selecting cache-line 310 when MSB=1. MSB-Mux 311 output is completely disabled when TRI=1 is chosen: de-coupling the bus 319 from memory-unit 300. This is when a different memory unit on the same bus may be used for data-transfers. When the memory unit 301 is engaged with TRI=0; DDR-0; MSB-Mux 311 is utilized during data read & data write modes. Drivers 316 facilitates a write-operation, to receive data into memory unit; and driver 315 facilitates read-operation, to send data out of the memory unit. Driver 316 and 315 control signals 313 and 314 respectively are derived by appropriate logic that received IN 329 and TRI 330 signals; only one of the drivers activated at any given time. The circuitry above MSB-Mux 311 is only active when DDR mode is selected. When DDR-0, pass gate 320 is off and drivers 323 & 322 are tri-stated, shutting off the coupling between memory unit 300 and second bus 325. However, when DDR=1 is selected; the top branch couple cache-line 310 to the second bus 325 for both read and write operations, concurrently with read and write operations of the lower branch. Blocks 316 and 317 represent the sense-amplifiers (SA). SAs may comprise single ended or dual-ended sensing. They may have pre-charge circuitry. They evaluate a data state of an input line: such as the outputs of MUX 311, or input 310 via active pass-gate 320. Outputs of SAs 317 and 321 are driven to buses 319 and 325 by drivers 315 and 322 respectively. SAs will be discussed in detail later. The SAs read the individual status of the bit-cell 301 in a given word-line. For a cache-line of 32-bits, there are 32-SAs in 317, and 32 SAs in 321. During SDR mode (DDR=0), the top 32 SAs in 321 may be turned-off to save power. During DDR mode (DDR=1), top 321 & bottom 317 SAs (64-in total) are active simultaneously to transfer 64-bits of data in two buses comprising 64-wires in one clock-cycle. Control signals for upper DDR branch drivers are shared with the lower branch in FIG. 3A; it does not need to be shared. Later we will discuss a Logic Boolean engagement of DDR signal to completely tri-state the upper branch drivers when DDR=0 is selected.

It is understood that memory unit 300 in FIG. 3A may be described as a half-band width memory unit by reversing the arguments. A single bus comprising wires shown in 319 and 325 may be divided into two half-buses. A primary coupling half-bus 319, and a secondary coupling half-bus 325. Then by activating the DDR-0 mode, only primary half-bus 319 gets utilized to read/write data from memory unit 300. A second memory unit 300 on the same bus 319 & 325 system may be coupled with bus 325 as its primary coupling half-bus. Then under half-data rate mode; both memory sub-systems may be utilized to transfer data, each memory sub-system accessing half the available band-width. This may be useful to improve memory transfers in multi-core SoCs.

Another embodiment for high band width memory data is shown in 340 of FIG. 3B. In this preferred configuration, the number of sense-amplifiers are reduced by 2× over 300 in FIG. 3A by eliminating DDR mode SAs 321 in 300. The memory array, and address decoding up to and including IO-Mux 348 are identical to FIG. 3A and is not discussed again. In 340, SAs 357 are utilized once during DDR-0 mode, and twice during DDR=1 mode: once to sense first cache-line 349, and second time to sense second cache-line 350. During DDR=0 mode, Mux 351 Boolean logic for decode signal 352 is controlled by MSB signal when IN=1. The MSB-Mux 351 selected cache-line needs one or more sense operation per read cycle to read the data. SA 357 is designed to operate within one clock-cycle, which is discussed later, but shown by a Boolean logic block coupled to SA 357. When DDR=0, CLK 371 signal gates SA 357 operation (one read per clock cycle). During DDR=1 mode, two sense operations are needed per clock cycle, to read the cache-line selected by MSB decode MUX 351. Control logic for MSB address signal 352 is generated by Boolean logic comprising DDR, MSB, CLK and IN signals to facilitate these two requirements, wherein CLK is the clock signal. The other signals were described in FIG. 3A. To facilitate the dual-SA operations, outputs of SAs are latched into latches 361. Boolean logic on decode signal 352 is controlled by CLK signal when IN=1 & DDR=0. Latch 361₁ & 361₂ are controlled by non-overlapping gated clock signals g1CLK and g2CLK respectively. The simplest non-overlapping gated clock signals are g1CLK=CLK and g2CLK=/CLK (not-CLK). When g1CLK=1, latch 361₁ is enabled, and g2CLK=1 latch 361₂ is enabled to capture SA 357 output data. when IN=1 & DDR=0, input gate 360 to latch 361₂ is always disabled, and gated g2CLK can include enable logic to disable the latch 361₂ clocking unnecessarily. Output driver 355 drives the captured data state via 358 on to bus 359. SDR data is received into memory unit 340 (memory write operation) when DDR=0 & IN=1. Date received on bus 359 by-passes SA 357 & latch 361₁ via input driver 356 and its coupled IN=1 enabled pass-gate 360. Drivers & logic in 356, 355, 353, 354, 369 & 370 are same as 316, 315, 313, 314, 330 & 329 respectively in FIG. 3A; 367 & 366 are also same as 327 & 326 in FIG. 3A. The word selected by MSB-Mux 351 address status of 352, selects one of the cache lines 349 or 350 to update write data. DDR=1 selects the double data rate mode wherein both buses 349 and 365 are coupled to memory unit 340 to receive and transmit data. When DDR=1, address 352 directs cache-line 349 to SA 357 when IN=0 & CLK=0, and cache-line 350 to SA 357 when IN=0, CLK=1. For simplicity, let's assume non-overlapping gated clock signals g1CLK=/CLK and g2CLK=CLK. Then CLK=0 enables latch 361₁, and CLK=1 enables latch 361₂. SA 357 works on a clock doubler, 2×CLK 372. During the 1^{st} 2×CLK cycle (while CLK=0), SA 357 eval data is latched into latch 361₁, storing cache-line 349. During the 2^{nd} 2×CLK cycle (while CLK=1), SA 357 eval data is latched into latch 361₁, storing cache-line 350. The 2×CLK is designed to output SA result in one 2×CLK clock cycle, at twice the frequency of memory unit operating clock CLK. This method may be scaled to operate one set of SAs at higher frequencies (say 4×CLK) and latching multiple cache-lines in latch banks (say to couple 4-buses). Non-overlapping gated clocks that operate latch operations may be controlled by a plurality of non-overlapping latch-enable signals to latch read data serially as required. Once latched, the output drivers drive data into a plurality of buses such as 359 & 365. When receiving data from buses 359 and 365, IN=1, latches 361 are by-passed via input drivers 356 and 363. Data on bus 358 is written into cache-line 349, while data on bus 365 is written into cache-line 350. It is also possible to use two CLK cycles to capture the data into latches 361 without using the 2×CLK clock by adjusting the control signals accordingly for SA 357 and latches 361. Then the data is transmitted in bus lines 359/365 every two cycles, useful when the bus-delays are very high.

A memory structure 380 in FIG. 3C comprises the use of double-clocked sensing for the DDR-mode discussed earlier. The memory features are described next using a bit-mode diagram showing four 8-bit (=1 byte) word cache-lines. A 4-byte word mode operation can be visualized by imaging 4-such blocks working serially, and a 4-way 4-byte word mode operation may be visualized by 4 copies of 4-byte word mode operations occurring in parallel. Memory unit 380 shows 8-words (also 8-bytes in this example) per word line 381; each word line 381 spans 8×8=64 memory (shown as 6T-SRAM) bits 383. In 380, one-word (8-bits) and two-words (16-bits) are accessed in SDR and DDR modes respectively. Extending these concepts, a QDR (32-bits) mode can be generated. If each word is 4-bytes, the SDR, DDR, QDR modes will be 4-bytes, 8-bytes & 16-bytes respectively. The read and write features are common with FIG. 3A & FIG. 3B with minor differences. In FIG. 3C, an SRAM cell array 396 comprises a plurality of 6T-SRAM cell 381, arranged in 1024×WLs 383, and 64×BL-pairs 382. In a 6T-SRAM, each cell comprises a pair of bit-lines, BL 382₂ₐ and/BL (not-bit-line) 382_{2b}. For a memory read operation, both BL &/BL are pre-charged to power rail V_{DD} by pre-charge circuitry 397. When a WL 383 is accessed, all 64 SRAM cells 381 coupled to the selected WL will transfer stored bit-values to BL (Data) and/BL (/Data) signal lines. The number of SRAM cells are not limited to 64 used as illustrated in 380. Bit-Cells are designed to prevent read-disturb; meaning a pre-charged BL &/BL pair will not cause a false write (data storage). During write mode three steps are taken: first BL &/BL are pre-charged to V_{DD} as before; second the write drivers are coupled to one or more cache-lines (a subset of SRAM bits 381) coupled to a selected WL 383 by switching IO-MUX 386₂ from a tri-state mode (where all inputs to IO-cells 387 are turned off) to a desired address-value (to couple a single BL/BL pair in each IO-cell 387) using an Enable signal EN 386₃; and third activating the WL 383 to store data in 396 array where the memory-write is needed. Cache-lines where write-drivers are not coupled to BL &/BL will not be disturbed, they will simply act as a read operation without altering previously stored bit-values. Cache-lines where drivers are coupled to BL and/BL will store the new values in memory-cells 381 selected by the WL 383. Hence cache-line updates can occur in one (SDR mode) or two (DDR mode) cache-lines at a time, in groups of multiple cache-line bits coupled to a single word-line. In SDR mode a single cache-line (8-bits) is updated, in DDR mode two cache-lines (16-bits) are updated. In 880, 4 bits of IO-cell 387₁ and 4 bits in IO-cell 390₂ are MSB-decoded by 388₂ and sensed in sense amplifier 395₁. Block 390₁ facilitate selecting IO-cell 387₁ or 387₂ for read operation. Block 391₁ facilitates coupling selected IO-cell 387₁ and 387₂ to bus 393 via port 392₁ₐ individually, or couple 387₁ to 393 via port 392₁ₐ and 387₂ to 394 via port 391_{1b} simultaneously to double the bandwidth. There are 8-parallel 391 blocks to provide 8-bit data for the 8-bit buses 393 & 394 shown. Subscripts denote parallel resources. In SDR mode one bit from one IO-cell is selected; and in DDR mode one bit from each of the two paired IO-cells are selected, each selected bit falls into two separate cache-lines; and the 8 pairs selected from 16 IO-cells 377₁-387₁₆ form two 8-bit cache-lines. Virtual to physical mapped memory data ensure proper sequence of data in a cache-line. Non-overlapping gated clocks (g1CLK & g2CLK) enable even cache-line data capture in 1 first line, and odd cache-line data capture in a second latch to facilitate the DDR data transmission. In one embodiment, g1CLK=/CLK, and g2CLK=CLK. In a second embodiment, gated clocks are derived by non-overlapping latch-enable signals. Gated clock signals for latches will be discussed later. During memory write, IN=1 in SA-control circuitry 389₁ puts the SAs 395 into pre-charge mode (signal 389₂=1, 389₃ are PMOS pullup transistors) and de-couple the SAs from BLs.

The BLs 382 in memory array 396 are grouped in a specific order to facilitate IO-Mux 386₂ and MSB-Mux logic 388₁ to select ordered data. Virtual-address and physical-address are scrambled for the decoding to provide MSB-LSB ordered contiguous memory access. In a cache-lines, counting up from the LSB, last 3 LSB-bits provides a sequential order (000, 001, 010, . . . , 111) of 8-bits in a cache-line. Eight “000” bits in 8-cache-lines are assigned to IO-cells 387₁ & 387₂ in even-odd arrangement: cache-lines 0, 2, 4, 6 in IO-cell 387₁, and cache-lines 1, 3, 5, 7 in IO-cell 387₂. Similarly, eight “001” bits in 8-cache-lines are assigned to IO-cells 387₃ & 387₄ in even-odd arrangement: cache-lines 0, 2, 4, 6 in IO-cell 387₃, and cache-lines 1, 3, 5, 7 in IO-cell 387₄. This is continued until the eight “111” bits in 8-cache-lines are assigned to IO-cells 387₁₅ & 387₁₆ in even-odd arrangement: cache-lines 0, 2, 4, 6 in IO-cell 387₁₅, and cache-lines 1, 3, 5, 7 in IO-cell 387₁₆. Counting from the address LSB, 4^{th} bit defined as the MSB in IO-Mux, decoded by MSB-Mux logic 388₁ selects IO-cell (387₁, 387₃, . . . , 387₁₅) with a Zero value, and IO-Cell (387₂, 387₄, . . . , 387₁₆) with a One value. Each selection is a cache-line, or in this example, an 8-bit word. IO-Mux address “0000” selects eight BLs (382₁, 387₉, 382₁₇, 387₂₃, . . . , 387₅₇) in first cache-line. Address “1111” selects eight BLs (382₈, 387₁₆, 382₂₄, 387₃₂, . . . , 387₆₄) in eighth cache-line. Memory address comprise address values 384 (for WL select), last 3 LSB addresses 386₁ for IO-Mux 286₂, and 4^{th} from last MSB address 388₂ for MSB-Mux logic 388₁ to decode a single word of a cache-line. For a 4-Byte word (=cache-line), 4 such groups in series will represent the cache-line, all selected simultaneously in exactly the same manner by selecting a word-line 383. In the 8-way Mux scheme (8 cache-lines accessible with 4-bit IO-Mux decode) shown in 880, one cache-line, or two sequential (even, odd) cache-lines are accessed out of the array having 64 BL-pairs. An array comprising 256 BL-pairs can provide a word comprising 4-Bytes, and 1024 BL-pairs can provide a word comprising 8-Bytes.

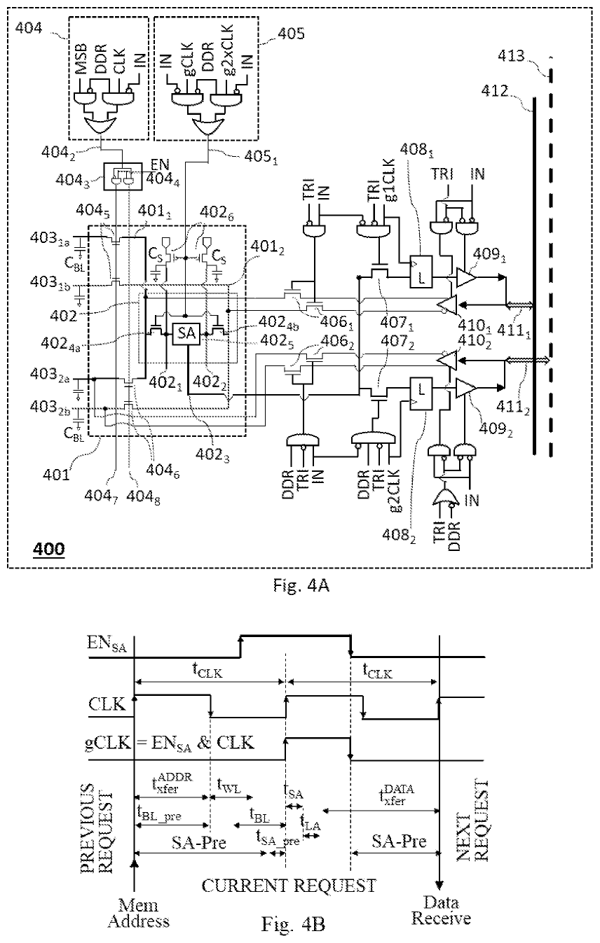

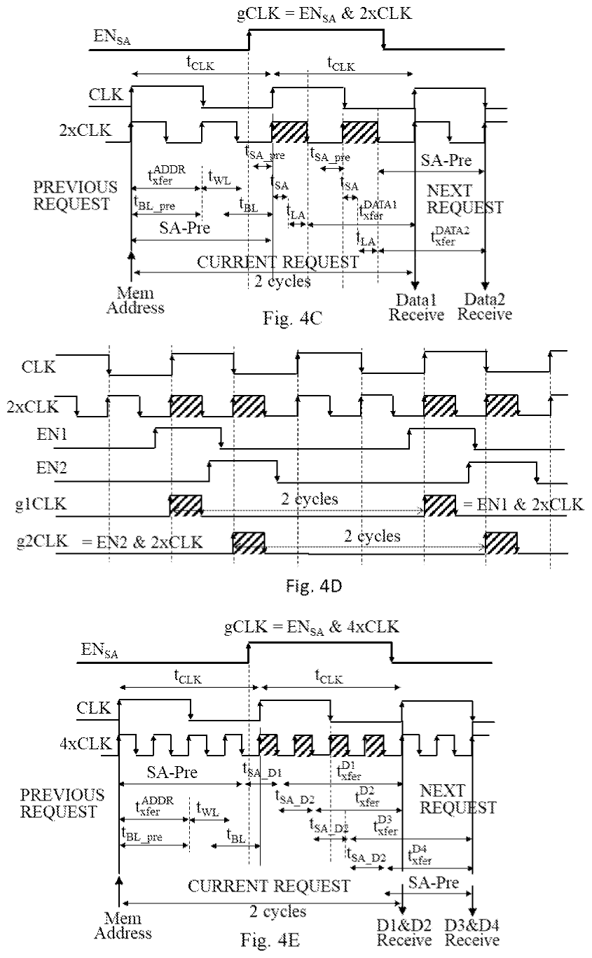

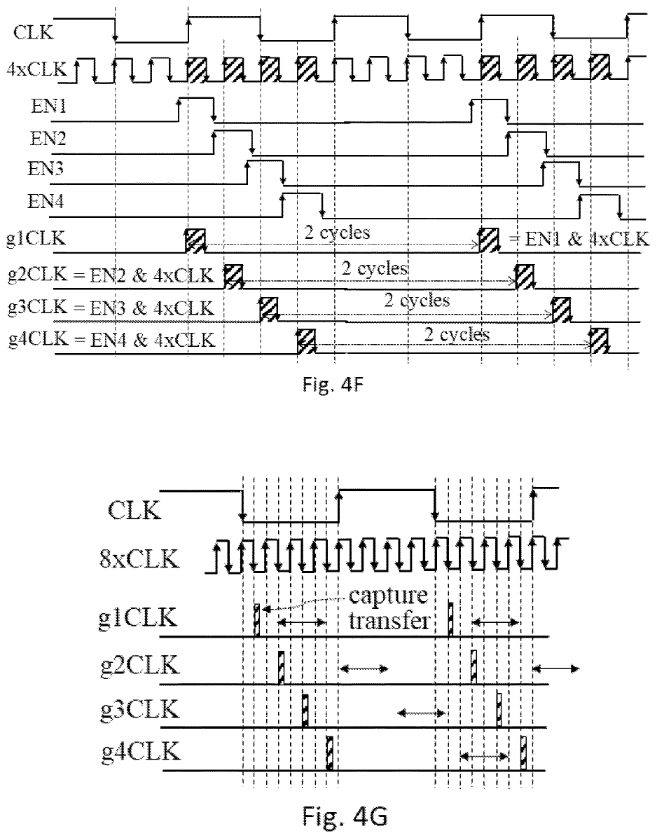

Comparing with prior-art FIG. 2B, a typical 4-bit IO-Cell 227 is separated into a 3-bit IO-Mux 386₂, and 1-bit MSB-Mux logic in 388₁. Four BL pairs 382₁-382₄ are grouped into 1st IO-cell 387₁, and next four BL pairs 382₅-382₈ are grouped into 2nd IO-cell 387₂, etc. With a 3-bit IO-Mux 386₂, eight consecutive BL pairs are combined into two IO-cell 387₁ & 387₂ in groups of four ordered as described in the earlier section. During memory read mode, address-lines 384, 386₁ & 388₂ are active. In a preferred embodiment, enable signals EN 386₃ and 388₃ facilitate a tri-sate option for Mux outputs in 386₂ and 388₂ respectively. Mux EN signals may be common, or separate. Pre-charge of 397 charge all BLs 382ₐ &/BLs 382_{b} to V_{DD} in the entire array 396. This pre-charge time t_{BL_PREc} contributes to memory read/write time, and it can over-lap the address transfer time t_{BUS}=t_{xfer}^{ADDR} for a memory request. Then address 384 defined WL (for 1024 WLs, it is a ten-bit address) is selected by address decode MUX 385. The selected WL driver has to charge this WL capacitance shown as C₆₄ in 396 to V_{DD}. Here C₆₄ denotes the total WL capacitance, including 64 pairs (128 transistors) of BL &/BL access transistor gates coupled to a WL. For 1024 BLs, this would increase by 16× higher (C₁₀₂₄). The WL-driver rise time constant is an RC delay associated with the WL resistance R and capacitance C₆₄. It scales with square of the length of WL. This WL rise time t_{WL} adds to memory access time. IO-Mux select-line 386₂ rise time is <t_{WL} since only 16 BL transistor pairs are coupled to it, and MSB-Mux select-line 388₂ rise-time is even lower as only 8 transistor pairs are coupled to it. In addition to transistor-gate capacitance reduction, the IO-Mux WL also reduce in wire lengths adding to a further square-scaling RC reduction to risetime. As the WL voltage is rising to V_{DD}, individual bit-cells 381 drive BL &/BL pairs to the data-state stored in each bit-cell along the WL. A pull-up PMOS in SRAM drives one of the BL-pairs to V_{DD}, while a pull-down NMOS in SRAM drives the other to GND. In the shown embodiment, due to pre-charge, PMOS does not have to pull-up a coupled BL or/BL, hence a weak PMOS is sufficient in the SRAM latch. It is not unusual to find a 1-fin PMOS FINFET transistor in an SRAM latch, while the NMOS has 2-fins. Only the NMOS pull-down is actively discharging a pre-charged BL or/BL. The pull-down current, termed I_{CELL}, is important to discharge BL-capacitance to a trip voltage value quickly (Δv=V_{DD}−V_{TRIP}), as the discharge delay t_{BL}=C_{BL}Δv/I_{CELL} adds to the memory read access time. During the time interval (t_{BL_PRE}+t_{WL}+t_{BL}), all BL &/BL pairs have reached either V_{DD}, or V_{TRIP} voltage levels. V_{TRIP} is designed to set a dual-ended sensing sense-amplifier 395 to read the status of a memory-bit by a trip-point in the sense-amplifier. Sensing advantages during read-mode of SDR & DDR sense-modes are described next using a two-bit sensing circuit 400 shown in FIG. 4A. The modes can be easily expanded to include QDR (quadruple data rate) and higher by expanding MSB-Mux from 2:1 to 4:1 to higher 2^{N}:1 for integer-N. For N-bit MSB-Mux, in one embodiment, 400 interacts with one bus, and in another embodiment, it interacts with N-buses. When MSB-Mux 404 is 4:1, four latches 408 can couple 4 cache-lines 403₁ₐ-403₄ₐ to four buses such as 412 & 413 to quadruple the cache bandwidth, each latch coupled to a bus via a driver 409. In 1-bus, the drivers would be multiplexed and clocked 4× faster to achieve 4× bandwidth. In 400 of FIG. 4A, where N=2 for MSB-Mux 404, it is understood that both drivers 4091 & 4092 may be multiplexed into a single bus 412, and the multiplexer control logic may be double-clocked to send cache-line 403₁ and 403₂ data one after the other at twice the memory operation clock rate, which is feasible when bus 412 wire delay is adequately low to transfer data. Unless specified, a 2-cycle memory clock is assumed in illustrations.

First the SDR READ mode selected by setting IN=0, TRI=0 and DDR=0 is described. In 400 of FIG. 4A, during READ mode, data is outputted from memory, the MSB-Mux 404 is tri-stated by EN 404₄ signal. Enable logic 404₃ is separately shown for simplicity, and it is may be combined inside the MSB-Mux 404 logic. MSB-Mux selects BL 403₁ or BL 403₂ to couple to SA block 402. In tri-state mode, both BLs are de-coupled from SA block 402 by forcing signal lines 404₇ and 404₈ to ZERO voltage. As described in 380, signal lines 404₇ and 404₈ have a shorter length, hence lower resistance R, and lower capacitance C₈ due to shorter length and less pass-gates coupled. When switching, these signal lines have a much faster switching time; signal rise and fall time constant RC is 5-10 times faster than the t_{WL} for a WL in the main array 396 of FIG. 3C. When MSB-Mux 404 is in tri-state, main array BL pairs 403₁ and 403₂ are decoupled from the sensing circuitry in 402. It took (t_{BL_PRE}+t_{WL}+t_{BL}) time for BLs 403 in the main-array to reach V_{DD} or V_{TRIP} voltage levels; one of 403₁ₐ or 403_{1b} is at V_{DD}, and the other at V_{TRIP}. Starting at the 412 & 413 bus connectivity end, when TRI=0 & DDR=0, only the upper-half of driver circuit (406₁-411₁) is active; the entire lower-half of both input and output circuits (406₂-411₂) are turned off by DDR=0 condition. Only bus 412 is coupled to SA block 401, and bus 413 in the mesh is available for any other memory unit to transfer unrelated data. In READ mode, TRI=0, IN=0, latch 408₁ is enabled by a gated clock g1CLK, latching data at the latch-input on the +ve phase of the gated clock g1CLK. It takes t_{LA} to latch the data. Pass-gate 407₁ is coupled to latch 408₁ only during the +ve phase of clock g1CLK, so the latch stores valid data from sense amp (SA) output 402₃ during+ve g1CLK cycle. We assume a level-sensitive latch to simplify the concept discussion, and it may be constructed as an edge-trigger latch. The simplest non-overlapping gated clock is g1CLK=/CLK, and g2CLK=CLK. It is preferable to use enable signals to gate the clock signals to chose latch-storage clock phase.

The SA-block 402 comprises a dual-ended sensing amplifier 402₅, having an output 402₃, two isolating transistors 402₄, two sensing inputs 402₁ & 402₂ and SA pre-charge circuitry 402₆. Signals to SA block 402 is generated by logic 405 output 405₁. In logic 405, gCLK is a SA-enable signal EN_{SA} (not shown) gated clock. In the simplest implementation, gCLK=EN_{SA} AND CLK, where AND is the Boolean AND-function. When DDR=0, logic signal 405₁=IN*gCLK, the double clock 2×CLK (also a gated double-clock signal) is disabled by DDR logic. When IN=1 (memory is in write mode), 405₁=1 logic level disables SA 402₅ as pass-gate pair 402₂ is turned off, and SA is biased to pre-charge mode. In pre-charge mode, the sense amp 402₅ inputs 402₁ and 402₂ comprising a small capacitance C_{S} are charged to V_{DD} by pull-up circuitry 402₆ very quickly. When IN=0 (memory is in read mode), 405₁=gCLK logic level enables a pre-charge during gCLK=0 (SA is decoupled from LLs), and sense during gCLK=1 (SA is coupled to BLs) cyclically. 405₁=gCLK=0 disables SA 402₅ coupling to BLs 403₁ & 403₂, isolating SA 402₅ from BLs, and pre-charge inputs 402 to V_{DD}; the SA inputs 402 pre-charge time t_{SA} PRE also being very short due to their isolated very-low node capacitances (not shown). Sense amp pre-charge can be done earlier during t_{BL} time for BL voltage settling if needed. gCLK=1 couples one BL pair (403₁ or 403₂) to common true and compliment inputs 401₁ and 401₂ for sensing; the BL pair coupling chosen by EN=1 in 404₃ & MSB value in MSB-Mux logic 404 that generates one of 404₇ or 404₈ at V_{DD} voltage level. Since the rise time of 404₇ & 404₈ are very short, during SDR mode, we can synchronize EN=1 to occur during the pre-charge time (−ve gCLK phase) or let EN=1 during IO-Mux decode stage. Let's assume MSB=1, which makes MSB-Mux output 402₂=1, turning off pass-gates 404₅, turning on pass-gates 404₆ to couple BL 403₂ₐ to 401₁, and/BL 403_{2b} to 401₂, both BL &/BL at either V_{DD} Or V_{TRIP} voltage levels. During gCLK=0 phase, signals 401₁ and 401₂ are at V_{DD} Or V_{TRIP} levels (due to coupled BL &/BL having a large capacitance C_{BL} determined by the memory array geometry and we have allowed t_{BL} time to reach V_{TRIP} voltage). Initially, SA is isolated from common input nodes 401₁ & 401₂ by pass-gates 402₄a & 402_{4b} at off-state. While SA is decoupled, sense-amp internal inputs 402₁ and 402₂ are pre-charged to V_{DD}. For this discussion let's assume 403₂ₐ=401₁=V_{DD} and 403_{2b}=401₂=V_{TRIP}. At CLK=1 transition, pre-charge pull-ups 402₆ are turned off, SA coupling gates 402₄ₐ & 402_{4b} are turned on. The very high C_{BL} capacitance of BL (402₂ₐ+401₁) at V_{DD} and/BL (402_{2b}+401₂) at V_{TRIP} arc coupled to much lower C_{S} capacitance of sense nodes 402₁ & 402₂, both pre-charged to V_{DD} voltage level. Charge transfer from a very low capacitance node to a high capacitance node occurs instantaneously, like emptying of filling a cup from a tank. SA input node 402₁ remains at V_{DD}, while input node 402₂ drops instantly by a voltage: ΔV_{SA}=[C_{BL}/(C_{S}+C_{BL})]*[V_{DD}−V_{TRIP}]. The sense amplifier response time t_{SA} is almost instantaneous. For a 3-nm process SRAM cell having dimensions 0.2 μm×0.1 μm, 1024-bit bit-line is >100 μm in length. A sense amp pre-charge node wire length is <1 μm. The bit-line capacitance (2k junctions+100 μm metal length) to SA-input node capacitance (<10 junctions+0.5 μm metal length) ratio >200×. BL voltage change during charge sharing is ΔV_{BL}˜(1/201)*(V_{DD}−V_{TRIP})˜0 mV. SA input node is sharing charge with a constant voltage source BL, and the time constant is for this change is “rc” of input node. Taking L2 as the RC-scaling for wire length, t_{SA}/t_{BL}˜(1/100)²; instantaneous SA inputs voltage separation compared to RC-time constant for BL settling, t_{SA}<<t_{BL}. This feature facilitates a novel use of multiple SA operation cycles within one BL-settling voltage cycle. During the +ve phase of gCLK, the SA 402₅ generates an output voltage 402₃ reflective of the input voltages it received: 402₂ₐ=V_{DD} outputs a logic ONE; and 402₂ₐ=V_{TRIP} outputs a logic ZERO as defined by the DATA state stored. This output value is latched into latch 408₁ during the same +ve gCLK phase within t_{LA} time to latch data. Latched data is driven out on bus 412 during the remaining positive phase of CLK signal, and next negative phase of CLK signal. Almost all of the memory access delay is in the memory address transfer time t_{BUS}, access time (t_{WL}+t_{BL}) and the data transfer time t_{BUS}. The timing diagram for READ is shown in FIG. 4B assuming a 2-cycle memory, 1 cycle to access the array and 1-cycle to sense and transfer the data. In FIG. 4B, the top EN_{SA} is the Sense-amp enable signal, positioned set-up delay earlier, and a hold-delay following the +ve edge of sense-amp data capture +ve half CLK cycle, shown below the EA_{SA} signal. gCLK (not shown) is the AND-function of the two (EN_{SA} AND CLK). It takes 2 CPU CLK cycles to retrieve data from the time an address is identified to receiving the data. During the first +ve CLK cycle, address is transferred to memory read port, while simultaneously pre-charging all the BLs. EN_{SA} forces SA-circuitry into pre-charge mode. During the first −ve CLK cycle, the WL & IO-Mux is accessed in t_{WL} time, and all BLs are allowed to stabilize in t_{BL} time to V_{DD} Or V_{TRIP} voltages. While BLs are stabilizing, EN_{SA} signal activates, maintaining SA inputs to pre-charge: this pre-charge time far exceeds the t_{SA_PRE} time needed to get 402₁ & 402₂ in FIG. 4A to V_{DD}. During the 2^{nd} +ve CLK phase, SA is coupled to selected BL, SA taking t_{SA} to trip, and SA output is latched taking t_{LA} time, the latch values driven by output drivers through the output bus consuming data transfer time

$${t}_{BUS} = {t}_{xfer}^{DATA}$$

to service the memory READ request. EN_{SA} hold time overlap of CLK signal t_{HOLD}>(t_{SA}+t_{LA}) time. Every two cycles, a data cache-line (aka data word) is received during the 2^{nd}−ve CLK phase via bus 412 in FIG. 4A. Depending on the CPU-clock frequency, the shown two data cycles may become 3 CPU clock cycles. The data word may be 1-Byte, 4-Bytes, or any number of Bytes.

The DDR READ mode selected by setting IN=0, TRI=0 and DDR=1 is described next. Front end data capture in BLs are identical to SDR mode, taking the same (t_{BL_PRE}+t_{WL}+t_{BL}) time for BLs 403 in the main-array 400 to reach V_{DD} or V_{TRIP} voltage levels. Starting at the 412/413 bus connectivity side, when TRI=0 & DDR=1, both upper-half (406₁-411₁) and lower-half (406₂-411₂) of driver circuits are active; the upper-half is coupled to bus 412, and lower-half is coupled to bus 413 to transmit 2× data compared to SDR-mode. During READ IN=0 decouples both input paths 406 in 400 of FIG. 4A. SA operation logic in 405 is controlled by g2×CLK signal since DDR=1. Generation of g2×CLK is shown in FIG. 4C. Sense amp enable signal EN_{SA} encloses two consecutive +ve clock phases on 2×CLK signal, which is a clock-double of CLK signal as shown. The sense-amp completes two consecutive READ cycles, first during the left shaded 2×CLK phase, and second during right shaded 2×CLK phase. This novel feature is enabled by separating the time-consuming WL selection t_{WL} event, and BL stabilization t_{BL} event coupling to the SA to facilitate a high-speed multi-cycle SA-operation. As cache-lines are physically separated, and all cache-line data in BLs are stable at the end of t_{BL}, SA can go through a plurality of (pre-charged, sense) operational cycles rapidly. In FIG. 4C, two such cycles are shown. As an example, the most advanced CPU operates ˜5 GHz frequency, where t_{CLK} is 200 pSec. Two cycles to operate memory aligns FIG. 4C with typical memories that operate at half the CPU frequency, and the concept can be extended to slower or faster memory clock rates. A half clock cycle is 250 pS in diagram of FIG. 4C. For 1024×1024 (1 Mb) memory arrays, best-in-class settling times t_{WL} & t_{BL}˜100-150 pSec (as the two t_{WL} & t_{BL} time components have some overlap, the total settling time is <250 pSec). In comparison, the t_{SA_pre} to pre-charge SA internal node is <40 pSec, preferably <20 pSec, and the sense and latch time (t_{SA}+t_{LA}) is less than 2-4 gate delays, about <50 pSec, preferably <30 pSec, which is the case in modern 3 nm FINFET advanced process technology. This facilitates a sense-loop cycle timing (t_{SA_pre}+t_{SA}+t_{LA}) to be <100 pSec, and preferably <50 pSec to allow DDR (for the former <100 pSec timing) or QDR (for the latter <50 pSec timing) sensing using the 5 GHZ CPU clock frequency, 2-cycle latency memory operation illustrated by FIGS. 4A & 4C. At the end of the first SA-operation, data belonging to first cache-line is latched and available for data-bus 412 transmission, transmitted data available at +ve edge of 2-clock cycles following the data-request signal. At the end of the second SA-operation, data belonging to second cache-line is latched and available for data-bus 413 transmission, transmitted data available at −ve edge of 2-clock cycles following the data-request signal (half a clock cycle later than the first data arrival). The sensing can continuously operate every two CPU clock cycles in FIG. 4A per timing shown in FIG. 4C. Sense amp is in pre-charge mode with BL-coupling disabled during the time it does not provide a sense operation. Sense-amp outputs are latched into two separate 408₁ via 407₁ & 408₂ via 407₂ in 400 by non-overlapping gated clocks g1CLK & g2CLK respectively. These two signals are generated by Boolean AND logic as shown in the signal diagram of FIG. 4D: g1CLK=EN1 AND 2×CLK, g2CLK=EN2 AND 2×CLK. Set-up and hold timing tolerances ensure enable signals to capture the two consecutive +ve phases of 2×CLK needed to capture the two sense-amp outputs into the two latches. A level sensitive latch is assumed. Each bus has a time duration of 2-CLK cycles to transfer the data before the next data cycle is latched for transmission.

Extending the discussed DDR-mode into a QDR-mode, in one memory array access, the sense-amp would be cycled 4-times to READ four separate cache-lines defined by MSB-Mux MSB bits: 00, 01, 10, 11. Using FIG. 3C, WL-address 384 & IO-Mux address 386₁ are identical in all 4 cache-lines, but the MSB-Mux logic 388₁ is adjusted to use 2-bits in a 4:1 MUXing arrangement. In addition, 4 buses such as 393 & 394, each bus having a bus-width matching the cache-line data width is needed. In QDR, the first two cache-lines will be received at the +ve edge of 2nd CLK cycle, and next two cache-lines will be available at the −ve edge of the 2nd CLK cycle following a data request. The gCLK and gated g1CLK-g4CLK for QDR are shown in signal diagrams of FIG. 4E & FIG. 4F. In FIG. 4E, the sense-amp enable signal EN_{SA} selects four data-sense cycles (shaded) in a 4×CLK derived from CPU CLK signal. Each phase activates a complete sense cycle, where t_{SA_Dn}=(t_{SA_Pre}+t_{SA}+t_{LA}) for the n-th selected cache-line sensing. FIG. 4F shows gated latch storage level signals to sequentially latch the four sensed data values D₁, D₂, D₃, D₄ into four lathes. Each latch is coupled to a different data bus to simultaneously transfer 4 separate cache-lines, first two D₁ & D₂ cache-lines are received at 2^{nd} +ve CLK phase, and D₃ & D₄ are received at second-ve CLK phase from data request +ve CLK edge. Each data transfer takes 2-cycles delay in the bus.

FIG. 4G illustrates setting up a memory array to comprise a stable READ output in +ve phase of a clock CLK, and use of QDR sensing with falling-edge triggered 8×CLK clock to capture data during-ve phase of the CLK clock into 4-latches. A major advantage with FIG. 4G is that 1-bus can transfer data at 4× the CLK speed, when the bus delay is sufficiently low to accommodate timing. In a preferred embodiment, the bus wire length is deliberately adjusted into wire-segments, with signal configurably buffered to facilitate this high band width data transfer. The 8×CLK signal may be generated by tapping into a delay chain from falling CLK clock edge. For a 5 GHZ CLK, the delay-line 8×CLK operates at 40 GHz, comprising a cycle time of 25 pSec and a pulse-width of ˜6 pSec. In this embodiment, the SA inputs are not pre-charged prior to sensing, they are simply switched from one input to the next at +ve edge of 8×CLK during-ve CLK clock phase. As we stated, a WL capacitance to SA-input capacitance ratio is 100:1, and the WL voltage change to SA voltage change ratio is 1:100 in magnitude. This means SA voltage can move from V_{DD} to V_{TRIP} and from V_{TRIP} to V_{DD} almost instantly when SA is coupled to a WL at V_{TRIP} or V_{DD} respectively, without the need to pre-charging SA inputs in between. In a discussion to be found later in this disclosure, we demonstrate that V_{TRIP} only needs to be near V_{TH} to detect a “0”, a trip voltage level in the range ½V_{DD}<V_{TH}<V_{DD}, preferably V_{TH}˜¾ V_{DD}. At that level, array pre-charge and READ “0” stabilization to V_{TH} can occur in the +ve clock CLK cycle (in the range 1 GHZ-5 GHZ), and QDR mode sensing can latch the instantly SA evaluated four cache-lines into 4 latch data-sets. Each latch has a ⅛ CLK cycle to set-up and capture the data, and a ¼ CLK cycle to transfer the captured data in the same bus; or it has ½ CLK cycle time to transfer the captured data in two buses. This is shown in FIG. 4G as capture, to show clock edge when data is captured in a latch, and transfer duration when the data is transmitted in the wire. By staggering the data transfers from each latch, the latch captured data can be transmitted at 4× the clock speed for a 4-latch buffer in a single wire. The latch data is fully transferred by the time the next data bit is captured in the same latch, and each latch has a safety margin not to override data before it has transferred previous data. Using 1-bus, in every CLK clock cycle, we get 4 cache-lines of data at 4×CLK clock-frequency, and wire-delays are segmented and buffered (discussed later) to ensure timing accuracy. In 1-wire we get 4× higher bandwidth, and in 2-wires we get 8× higher bandwidth. This is a significant bandwidth boost for modern CPU cache memories.

The advantages include following aspects. A first advantage is allowing a single access of a set-associative cache memory to amortize the time of access across a plurality of cache-lines coupled to the same physical word-line. A second advantage is decoupling a sense amp input sense-node from the array bit-line, such that the instant charge sharing (SA input RC-delay compared to BL RC-delay) between high capacitance bit-line and low-capacitance sense-input allows instant sensing. A third advantage is in the ability to increase the V_{TRIP} voltage of the bit-line closer to V_{DD} due to the charge-sharing benefit ripple down to a higher bit-line V_{TRIP} voltage. Another advantage is in the ability use less area (lower cost) for sense-amps due to time-share (re-using same SA many times) factor to amortize cost. Another advantage is reduce-power in SA-circuits due to pre-charge state and very-fast sense times lowering the sensing power requirement (less SA idle time that waste power).

Next the SDR WRITE mode selected by setting IN=1, TRI=0 and DDR=0 is described. In 400 of FIG. 4A, during WRITE mode, data is inputted to memory. A cache-line data arrives on a single bus 412 and must be stored in the correct WL. The MSB-Mux 404 is activated by EN 404₄ signal. Enable logic 404₃ may be combined inside the MSB-Mux 404 logic if needed. MSB-Mux 404 logic output 404₂=MSB since/DDR=1, selecting 404₇ or 404₈ with MSB=0 or MSB=1 values respectively to couple BL 403₁ or 403₂ to couple to IO block 401. Data by-passes SA 402 in pre-charge mode with internal input nodes 402₁ & 402₂ decoupled from BLs. Input drivers 410 write the cache-line data during the 3^{rd} phase WL activation of write-mode (previously described). Only one cache-line write data, the remaining cache-lines are un-disturbed at previously stored data values. The DDR WRITE mode is selected by setting IN=1, TRI=0 and DDR=1. Input data by-passes SA 402 in pre-charge mode with internal input nodes 402₁ & 402₂ decoupled from BLs. Two cache-lines of data arrives on the two buses 412 & 413 and must be stored in the correct WL: one cache line having an MSB=0, and a second cache-line having an MSB=1. The MSB-Mux 404 is activated by EN 404₄ signal. MSB-Mux 404 logic output 404₂=0 since/DDR=0, selecting 404₇ for MSB=0 data path to couple BL 403₁ to input driver 410₁. Input driver 410₂ is coupled to BL 403₂ via pass-gates 406₂ driven by DDR=1, TRI=0, IN=1. Bus 412 data is coupled to MSB=0 cache-line; and bus 413 data is coupled to MSB=1 cache-line. Both sets of input drivers 410₁ & 410₂ write both cache-line data during the 3rd phase WL activation of write-mode (previously described). Only two cache-lines write data, the remaining cache-lines are un-disturbed at previously stored data values. In a QDR mode (not shown) for buses such as 412/413 in 400 of FIG. 4A will couple to four cache lines defined by MSB 00, 01, 10, 11 and simultaneously write 4 cache-lines into a single WL & IO-Mux address.

All figures FIG. 3A-3C and FIG. 4A do not show a latch in the write-path. Analogous to a READ cycle, a WRITE cycle also comprises dissimilar timing components: (i) wire delay to receive data in a bus, (ii) all BL pre-charge delay to prevent Write-Disturb on un-selected cache-lines on the same word-line, which can overlap with previous, (iii) write bit-line settling time to set up write voltages on selected cache-line, and (iv) write word-line pulse time to capture the write data. When wire delay to receive write data is much faster than the write bit-line settling time, latch-buffers in the write path can improve the bandwidth of a write cycle, similar to the latch-buffers in the read-path to re-use SA-structures. In a preferred embodiment, the invention includes a plurality of latches in the read and write paths to achieve double or quadruple bandwidth in cache memory access. In another preferred embodiment, the invention includes sharing a plurality of latches between the read and write paths to achieve double or quadruple bandwidth in cache memory access. This will be discussed later.

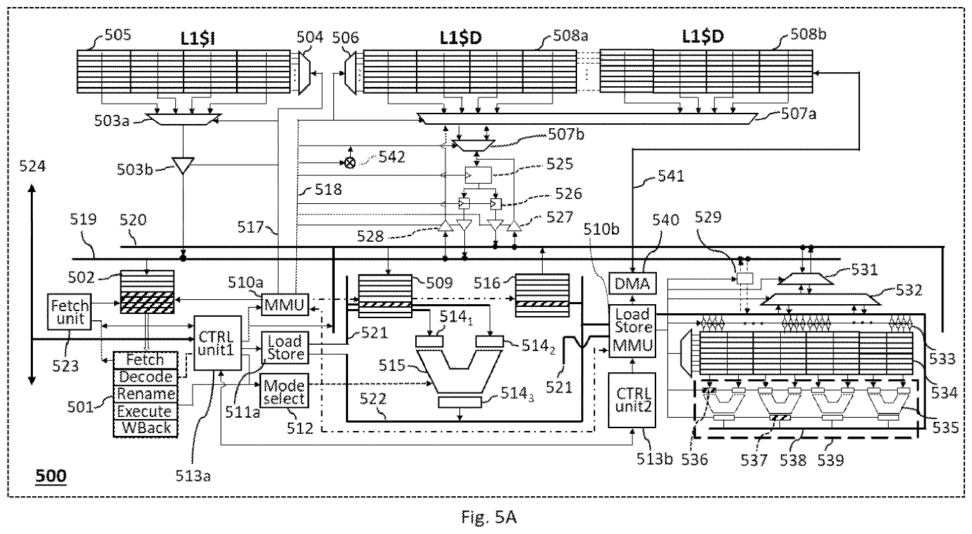

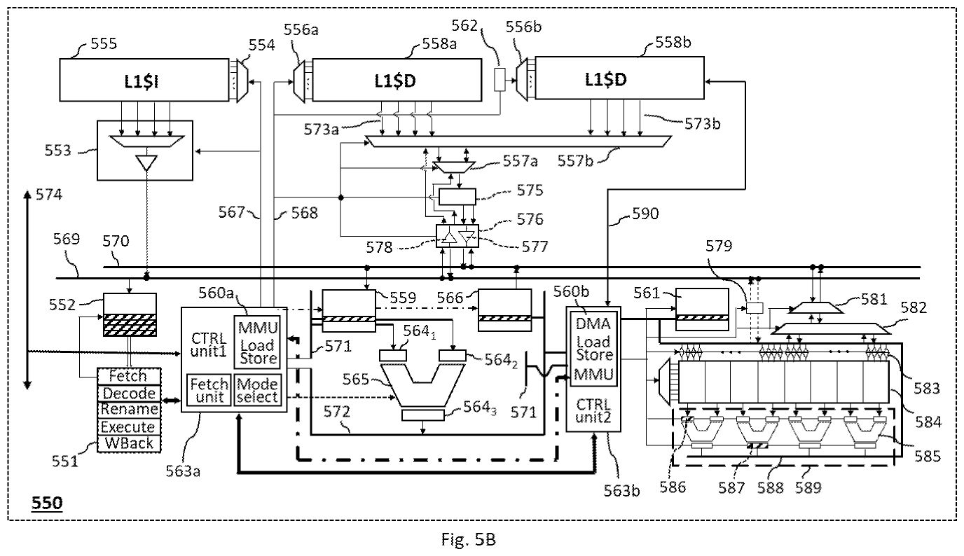

A novel pipelined accelerator high bandwidth computing CPU-core is shown in 500 of FIG. 5A. The figure is shown as an extension of 220 in prior art FIG. 2B to easily identify and discuss the differences. CPU 500 comprises a high bandwidth compute programmable logic hardware block 539 wherein highly complex user defined functions can be instantiated by configuring the block using firmware bit-code. This FW is generated by design software development kits that convert the high-level software code (in python, C, C++ etc.) into FPGA-style RTL based gate level netlist defined by the bit-code of the FPGA fabric. The highly complex function is shown as hardware block 535, and it may comprise one of more of a single function, a plurality of SIMD functions, and a plurality of MIMD functions. These complex functions utilize a plurality of input registers 536 and a plurality of output registers 537 inter-connected via a configurable mesh 538. The FPGA hardware, once programmed, acts as a domain specific accelerator (DSA) to the user, adding ASIC-Accelerator capability inside the CPU-pipeline 501. This unit is termed a Flexible Accelerator Unit (FAU) 539. An ISA-instruction decoded as a CPU-instruction in 501 is steered to the CPU-hardware 515, while a Function-instruction in 501 is steered to the FAU 539. FAU 539 is capable of handling very high bandwidth data inputs in 536. A typical 32-bit RISCV CPU use two fixed 32-bit input data for CPU compute unit 515, and it has an ISA defined limit of having 32-Registers (32 words, each word 32 bits) for input/output data 514 at any given time. In comparison, input registers 536 are flexible, 8 b-64 b based on application requirements, or even lower or higher, and the number of total input bits may be 1024 b at a time, or 2048 b at a time. This allows the FAU 539 to massively parallelize computing; and unlike GPUs, these functions do not have to be limited to SIMD (single instruction multiple data), it can be MIMD (multiple instruction multiple data). A high band width scratch pad memory L0-Cache 533 (L0$D) is coupled to the inputs 536 and outputs 537 of the FAU 539 via configurable interconnect-fabric 538. In a single cycle 1024 b or 2048 b or a subset of input data can be clocked from L0$D 534 into FAU 539 inputs 536, and a second memory management unit (MMU) 510b comprising data load from & store from L0$D 534 manage this activity.

System bus is 524 (244 in FIG. 2B); 525 is clocked DDR MUX (311 in FIG. 3A); plurality of 526 is sense & latch circuits (such as 357, 361₁, 361₂ in FIG. 3B); 527 & 528 are I/O buffers (such as 356 & 362 in FIG. 3B); 529 is a data control switch; 531 & 532 are bi-directional data MUXs; and 542 is a configuration bit. Instruction-data is received in instruction buffer 502 from L1$I 505 via bus 519. Compute-data is received in load buffer 509 from L1$D 508 via bus 520, and compute results are written back from store buffer 516 back to L1$D 508 via same bus 520. Control unit-1 513a, MMU 510a, and fetch-unit 523 coordinate the instruction flow and data flow. Mode select unit 512 selects HW unit 515 function. Instructions and data are transferred between caches and buffers in cache-line block sizes. A single cache-line may be 64-bytes, which is 512-bits, requiring each bus 519 & 520 to have at-least 512 wires, combined at-least 1024 wires. Other requirements may increase the needed bus-width, but approximately both buses 519 & 520 have balanced band-width. Instructions and data are received simultaneously in the two buses, instructions only moving one-way from L1$I 505 to buffer 502, while data moves both ways between L1$D 508 and into buffer 509 & out of buffer 516. L1$I and L1$D address buses from MMU 510a are 517 & 518 respectively. In an out-of-order (OOO) super-scalar pipeline that supports two threads, there can be a maximum of 8 instruction pipelines 501; groups of 4 pipelines managing an individual thread, the fetch unit bringing 4 consecutive instructions every cycle into 4 parallel pipelines such as 501. A group of four “per-thread” pipelines share a common execution stage, where OOO execute instructions are queued in buffers waiting for availability of HW unit 515 and related data in load buffer 509. Instructions never cross threads, and each thread comprise non-overlapping data addresses not to cause data-contention. An ISA-instruction in decode of 501 is steered into CPU-execution hardware: “load” into 509, “store” from 516 and “math/logic” using general-purpose-registers (GPR) 514 in execution unit 515. Load/store unit 511a manages data-flow, fetch unit 523 manages instruction-flow, while control unit (CU) 513a together with memory-management-unit (MMU) 510a provides proper sequencing of control signals to get data and make the HW work correctly. A program counter in fetch-unit will bring a thread of work load instructions from beginning to end using control unit 513a & MMU 510a, each instruction assigns data-movement or data-operations also handled by control unit 513a, MMU 510a, L/S unit 511a & Mode-Select 512. Instructions and data flow continuously from L1I$ 505 and L1D$ 508a continuously utilizing buses 519 and 520 respectively into instruction & load/store buffers 502, 509 and 516 in block sizes of a cache-line. The cache-line is a hardware decision, and is physically bounded by an address range. For 64-Bytes, the range defined by the 9^{th} MSB in big-endian is [xxx,000,000,000] to [xxx,111,111,111]. As instructions and data are approximately evenly balanced, both buses are utilized efficiently.

The novel feature in CPU 500 is that significant amounts of instruction code can be converted into a single Function-Instruction, a hardware DSA, that is programmed into FAU 539 by firmware. The firmware function programming may be static at a program load time, or dynamic at a program run time. The function instruction is fetched by fetch-unit 523 just like any other, and during decode stage in 501, it is assigned to the FAU 539 hardware domain. To facilitate high bandwidth computing, the FAU 539 is coupled to a very high bandwidth local L0-cache (L0$D) 534. In a single READ command, it may output 1024 b of data, or 2048 b of data. For 1024 b of a data-word in L0$D 534, two cache-lines of 64 B each in L1$D is outputted as a word. There is a significant imbalance between instructions and data, as explained in FIG. 2C, this disadvantage is turned into an advantage by using both buses 519 and 520 to transfer data between L1$D 508 & L0$D 534; while L1$I 505 is tri-stated, or disabled by 503b or 503a respectively. As described in FIGS. 3 & 4, two consecutive cache-lines in L1$D are transferred into L0SD utilizing the novel DDR-mode. A series of 32 cache-line DDR copy commands (assuming 512-wire buses 519/520) can transfer a 4 KB data-page. In a first embodiment, this data transfer is handled by the same CPU cache coherent infrastructure first-set comprising L/S unit 511a, MMU 510a and CU 513a, while the data transfer and FAU execution once the data is in L0SD is handled by second-set comprising L/S/Mem unit 510b, a DMA 540 and CU 513b. In a second embodiment, the L1$D to L0$D data transfer is handled by said second-set, working in conjunction with said first-set.

The data management infra-structure in FAU 539 comprises a direct memory address DMA unit. It has the capability to share MMU 510a (by MMU coupling) or take-over (by 541 coupling) the L1$D addressing to bring data into L0$D when told to do so by CU 513b (after ensuring there is no data-conflict with the needs of CU 511a). It also can address L0$D 534 memory space to service the needs of FAU 539 execution: load data into inputs of FAU, and store results back by engaging L/S/Mem unit 510b. Within L0$D space of computing, there is no data-conflict with Load/Store units in 509 & 516 by design. Data dedicated to FAU resides in L1$D and L0$D when DMA 540 is engaged by CU 513b. When the DMA 540 needs a cache-line address not available in L1$D 508, it informs the MMU 510a (directly, or via MMU 510b) to trigger a cache-miss that propagates thru the coherent cache memory hierarchy until the required memory address is located, even if that is an off-chip storage address, and the data is retrieved to L1$D. The DMA 540 does not violate automatic cache updates in cache-memory hierarchy. Existing DMA support for accelerators requires to stop cache memory updates, halting CPU operation, when the DMA is in use. This innovation allows the CPU to function when the DMA is in use.

CPU 500 comprise two control units 513a and 513b, a detailed description of which is provided in incorporated by reference patent applications. The CUs work in Master-Slave mode. During ISA-instruction execution, CU 513a acts as the master, while CU 513b is the slave. One or more status registers or configuration bits can change the mode between the two. During Function-instruction execution, CU 513b acts as the master, while CU 513a is the slave. Both CUs can configure the master-slave mode by hand-shake to take-over the supervisory role. The term CPU-mode is used when CU 513a is the master, and FAU-mode is used when CU 513b is the master. During CPU-mode, CPU 500 executes ISA-instructions and FAU-functions concurrently. Bus 519 fetch instructions, and bus 520 transfer data. All ISA-instruction data is in load 509 buffer (for pending instructions), and in store 516 buffer (for completed instructions). As an example, an ADD instruction is demonstrated. Two LOAD commands precede the ADD command to move input data from load buffer 509 to load buffer 509. During ADD command moving thru 501, decode stage recognizes ADD command, rename stage moves two bytes of data into GPRs 514₁ & 514₂, during execute stage mode select 512 picks the ADD configuration and does the addition (however many pre-determined clock cycles it takes) the output result written into GPR 514₃. The 501 write-back stage moves the GPR 514₃ value into store buffer 516. A STORE command is needed to move the store buffer 516 result to L1$D 508. Loads and Stores are done in cache-line data size blocks. Skipping writeback in 501 allows the GPR 514₃ value to remain inside the fixed 32-wide GPR, and move to a different GPR address using a move command, and reuse it in an immediate next execution (such as multiply and accumulate). Once the data value is in store buffer 516, it must retire back to L1$D and get re-fetched back to load buffer 509 for reuse. Cache memory data coherency, cache misses and data requests are maintained by MMU 510a design and its relationship to L/S 511a and CU 513a. When a FAU-instruction (aka a Function Call, which is an ISA specified RISCV instruction that allows it to be a custom accelerator) is received in 501, in decode stage it gets assigned to the FAU. As the FAU is pre-programmed to exactly match the functionality, no specific instructions-bits equivalent to mode-select is needed. The function call can be one of a plurality of DSA functions programmed into FAU 539. In CPU-mode, data is received into load buffer via LOAD commands. Rename stage moves FAU data from load buffer 509 in CPU compute space to L0$D in FAU compute space in one of two ways: (i) using a data transfer-buffer (not shown) similar to GPR registers, specially constructed to act as a buffer between load-buffer 509 and L0$D cache 534, and assigning L/S/Mem 510b to copy that data into L0$D, or (ii) directly assigning L/S/Mem 510b to copy the data from load buffer 516 to L0$D utilizing data bus 521 extended to couple into unit 510b. In a preferred transfer-buffer scheme, both load/store units 511a and 510b have access to each other via bus 522 to place shared data and pass parameters between the two CPU and FAU compute spaces. This is a novel way of passing stack-pointers and heap variables between heterogeneous compute spaces to significantly improve back-and-forth computing in heterogeneous high-performance-computing (HPC). When CU 513b is in slave mode, master CU 513a can assign function-calls to slave CU 513b to execute in FAU, passing the required data. The FAU executes the function, the result available in registers 537 coupled to bus 538 for retrieval. L/S/Mem unit 510b under purview of CU 513b can return results to either L0$D 533, or to a transfer-buffer (not shown). When slave CU 513b signals completion of FAU execution, CU 513a can retrieve the result back to load buffer 515 for CPU executions, or to store buffer 516 to store the result back in L1$D. A plurality of ports serviced by bus 538 may be controlled by configurable tri0stae drivers, or configurable muxes. In one embodiment bus 538 comprises a programmable interconnect fabric, a plurality of configurable elements providing the port select ability. The configurable element may comprise a memory element. This back-and-forth heterogeneous computing between CPU-HW and Accelerator-HW is novel. Both CPU and Accelerator use the same cache hierarchy to reduce power and increase compute bandwidth. In CPU-mode, a load instruction brings 64B of cache-line data into buffer 509, and L/S unit 511a move this data using L/S/Mem unit 510b into L0$D 534. In a preferred arrangement, a single high bandwidth READ operation in L0$D outputs 128B of data, equivalent to two CPU-mode L1 instruction and data cache-lines. Then two cache-lines of data may be copied from load buffer L0$D space for the FAU to operate. After FAU execution, the resulting one cache-line of data may be brought back into load buffer 509 for unit 515 to reuse, or to store buffer 516 for the L/S 511a to save in L1$D 508.

When an FAU-instruction enters the instruction pipeline 501, at decode stage the instruction is assigned to FAU 539. Since an FAU instruction is pre-programmed into programmable hardware in 539, it does not contain equivalent instruction bits used in mode-select 512 (such as OR, NOR, AND function select for an ALU), instead it may comprise TAG or Action bits for CU 513b. It may also comprise one or more control-status bits for the CU 513a to assign master control status to CU 513b, and become the slave CU. CU 513a will remain slave-CU, taking actions as specified by CU 513b, until the status is reversed by CU 513b. At any one time, there is only one master CU, and one slave CU, the master capable of switching the ownership to the slave when desired. During FAU-mode, the CU 513b acts as the master, and CU 513a becomes the slave. This mode is useful when a large body of data is expected to compute in FAU 539, such as the 1024 consecutive ADDs or MACs described in FIG. 2C. A single Function-instruction is able to execute 1024 consecutive executions without the need of instructions in pipeline 501; instead, the instruction is programmed by firmware in FAU 539, and CU 513b working with L/S/Mem 510b and DMA 540 enable inputs loading and results storing. Configurable bus 538 programmed for the specific FAU-function provides the port connectivity needed. As there are no instructions to retrieve from L1$I to instruction buffer 519, the bus 519 utilization is zero, wasting valuable resources in CPU 500 HW. The FAU is a high-compute accelerator, the compute capability limited by the data bandwidth of getting data from L1$D 508 to L0$D 534. Master CU 513b working with slave CU 513a is able to tri-state (using drivers 503b) or decouple (using 503a mux coupling) L1$I 505 from its dedicated bus 519, and couple bus 519 to L1 D-cache L1$D 508 to double the bandwidth of data transfer to support FAU 539 function computing. A first advantage in this scheme is, preceding the function-instruction, a load instruction has ensured 4 KB page data arrival into L1$D, and a copy of the first one or more 64 B cache-lines of data (in the 4 KB page) arrival into load buffer 509. In CU 513b in master mode, when load buffer 509 has two or more cache-lines of data, L/S/Mem unit 510b can grab the first two cache-lines of data from load-buffer 509, and instruct L/S 511a in slave-mode to flush the used data, and instruct DMA with an address pointer to fetch high bandwidth DDR-mode data from L1$D from the next dual incremented cache-line, fetching two cache-lines at a time by incrementing cache-line address two at a time. As described in FIG. 4, both buses 519 & 520 are utilized to fetch 1024 b in a two CPU clock cycles. In a preferred embodiment, the FAU operates at ½ the clock cycle of a CPU. For example, when the CPU operates at 5 GHZ, the FAU operates at 2.5 GHZ. Therefore, every FAU clock cycle, 1024 b of data arrives from L1$D into L0$D. The latency of data arrival is 2 CPU clock cycles, which is 1 FAU clock cycle. In another compute embodiment, FAU 539 inputs are directly coupled to the L1$D 508 DDR-mode read ports that fetch 1024 b of data every FAU clock-cycle. The outputs are coupled to L0$D to save results, the address automatically incrementing every FAU clock cycle. For 1 FAU clock cycle operations, FAU executes 1024 b (=128 B) of input data, generating however many bits of data as defined by the function implemented, saving the result in L0$D. This batch-mode compute operation can continue until L0$D 534 is filled, or L1$D 508 is emptied, which ever is the first halt data flow. For ultra-high bandwidth CPU 500, bus 519 & 520 may comprise 1024-wires, thereby facilitating transfer of 1024 b of data in SDR-mode, 2048 b of data in DDR-mode, and 4096b of data in QDR-modc.

As described with respect to FIG. 4, high bandwidth CPU 500 L1-cache comprises SDR, DDR modes and is scalable to include QDR mode. In big-endian nomenclature, muxes 504 & 506 comprise the MSB-address bits, while IO-muxes 503 & 507 comprise the LSB-address bits. For L1 data-cache L1$D 508, IO-mux 507a chooses one cache-line from a plurality of cache-lines in set associative cache structures 508a and 508b. For 64-Byte cache-line, this is 512 bits from each of the two memory blocks 508a and 508b. MSB-mux 507b allows selecting one of the two cache-lines identified by IO-mux 507a in SDR mode, or both in DDR mode as described earlier. Memory data transfer is bi-directional between L1$D and L0$D caches. L1$I 505 is modified to include a decouple state so that in DDR mode, the I-cache bus is used to transfer data. Master-Slave features of the two control-units 513a & 513b manage SDR & DDR data transfer in CPU-mode & FAU-mode respectively.

A second embodiment of a pipelined accelerator high bandwidth CPU 550 is shown in FIG. 5B. System bus is 574 (524 in FIG. 5A); 553 is same as 503a,b in FIG. 5A; 576 is combined 526, 527, 528 of FIG. 5A; 578 & 577 are I/O buffers; 579 is a control access switch; and 581 & 582 are same as 531 & 532 of FIG. 5A. Control unit 563a is shown to comprise MMU, Load/Store units, Mode-Select unit and Fetch unit to simplify the diagram. MMU & L/S units are grouped as 560a. Control unit 563b is shown to comprise DMA, MMU, & Load/Store units to simplify the diagram. DMA, MMU & L/S units are grouped as 560b. The main difference in CPU 550 compared to CPU 500 is an address offset 562. One or more higher-order MSB address bits in 558b is an incremental offset (+ve or −ve) from the equivalent address bits in 558a. This is explained next using an example. For 64-Byte cache-lines (=512 bits), each cache-line is an increment of the MSBs greater than or equal to the 10^{th} bit, the cache-line identified by address range: [xyz,000,000,000] to [xyz, 111,111,111]. Data is always stored by physical alignment of cache-lines, meaning the last 9-bits are always physically aligned in a cache-memory structure that undergoes either page-copy or cache-line copy. A copy command [xyz/90/]-[xyz/91/] will copy a cache-line, where/90/notation means nine zeroes. In defining a large matrix, in software it is done by assigning a dimension and a byte-definition. For 1024 double word (32 bits=4 bytes) numbers, a memory space of 4096-bytes is assigned. These would get placed in cache-lines, 512 b per cache-line. In virtual space the address is contiguous, but in physical space the bytes are not contiguous, rather only a cache-line is contiguous. A virtual to physical mapping provides the cache-line breaks and jumps to map virtual addresses to physical. There is always a translation in getting an address. In a large class of math-operators, such as matrix multiplication or addition, two sets of identical dimension variables are used in computations. As an example, in A+B=C, a 4B value A is added to a 4B value B, and the result may be saved as an 8B value C. Both A & B are needed to compute C. A CPU must request A-data, then B-data, so both are available in L1$D to begin computing C. If L1$D has both A & B data, at least 1 cache-line of each has to be copied into load-buffer, and computing C must wait until this copy is done. If L1$D docs not have A & B data, it must be retrieved from L2$D first, this retrieval occurs in 4 KB pages. Now the wait (latency) is horrendous: first 8 KB of A-data+B-data is copied from L2$D to L1$D, then 128 B cache-lines of A-data+B-data is copied from L1$D to Load-Buffer to start computing C. As dual-port SRAM consumes a large area, all large cache memories do not provide simultaneous read and write capabilities due to data corruption in single-port SRAM memories. In specifying A & B, two non-overlapping virtual memory spaces are allocated to store A-data and B-data, these two memory spaces are separated by a fixed offset in the MSB-address bits. If they are assigned as a contiguous space, it is simply a 4096-bits offset, which is the 13^{th} bit in binary addressing (13^{th} bit 0 and 13^{th} bit 1). By simply incrementing the 13ₜₕ bit by one, we can get the matching A and B values in ordered (a, b) numbers. Since the virtual to physical translation is stored in a TLB, by simply incrementing the 13^{th}-bit (in this example, or a higher order one or more MSB bits in all cases) we can always identify the paired values (a, b) for vector addition. Offset 562 in CPU 550 reflect this separation of orderly-paired numbers defined by software. Use of a 1025-offset defined by software coding is shown in prior-art (a) of FIG. 2C. The DDR-mode in 550 provides a method to transfer a first cache-line of A-data from L1$D 558a, and a matching second cache-line of B-data from L1$D 558b concurrently with one or more MSB address offset to reduce the latency delay in computing C-data. Latency reduction improves compute thruput.

In 550, each of cache 558a & 558b comprises a memory array such as 396 in FIG. 3C. A first address received at 556a selects a first word-line in cache 558a; and a second address is computed by an off-set of a plurality of MSB-bits in said first address by logic in 562; the second address received by cache 558b selects a second word-line. Each of the first and second word-lines comprise a plurality of cache-lines that undergo a common lower-order address bit decode in mux 557a to select a first cache-line from cache 558a, and an address off-set second cache-line from cache 558b. Read path utilizing sense-amps 575 comprising latches to latch DDR-mode read data (not shown), and output drivers 577 provides coupling of said first cache-line to bus 570, and said second cache-line to bus 569 for data transmission. Write path utilizes input drivers 578, by-passing sense-amps 575. Said first cache-line in 658a is coupled to bus 570 via mux 557a, and said second cache-line in 558b is coupled to bus 569 via mux 557b. Data received in buses 570 and 569 are written into the selected first cache-line in cache 558a and second cache-line in cache 558b respectively. In SDR-mode, only a single bus 570 is used to transfer read and write data to one of the two cache structures 558a or 558b using both muxes IO-Mux 557a and MSB-mux 557b.

High bandwidth CPU 550 in FIG. 5B show the data-transfer (Xfer) buffer 561 to transfer local compute data back and forth between CPU 565 compute space and FAU 589 compute space. The Xfer-buffer 561 is coupled to load buffer 559 and store buffer 566. Control units 560a and 560b acting in master-slave modes that can alternate transfer data from one space to the other for back-and-forth computing between CPU instructions and FAU accelerator functions. CPU compute unit 565 utilizes GPR registers 564 to compute, while FAU 589 utilizes input ports 586 and output ports 587 to compute. FAU ports are coupled by a configurable interconnect fabric, and it can receive and save data to Xfer-buffer 561 and/or L0$D 583 cache. Input/Output drivers 583, constructed similar to IO-drivers in 576, are described in detail in FIG. 3 and FIG. 4A. By-pass 579, IO-mux 582 and MSB-mux 581 provide SDR-mode and DDR-mode coupling of data bus 570 and instruction bus 569 to FAU cache L0$D 584.

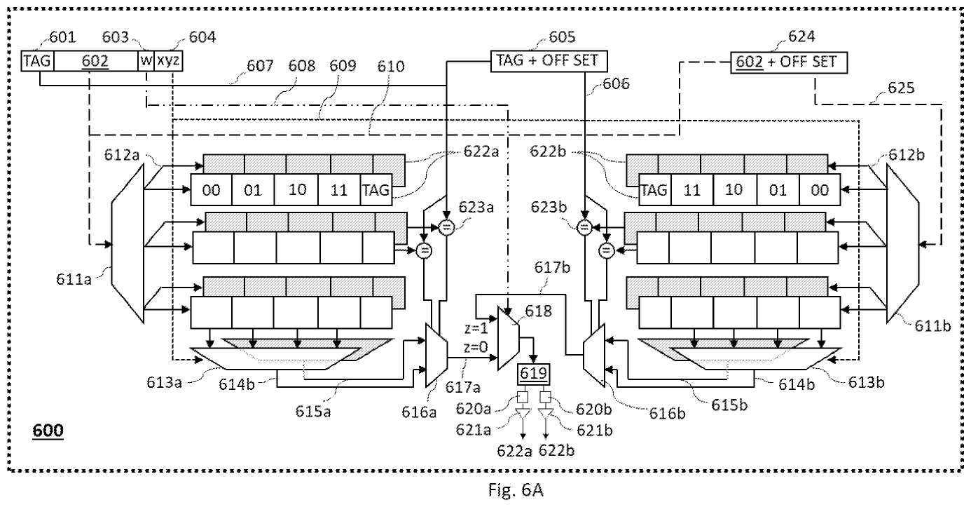

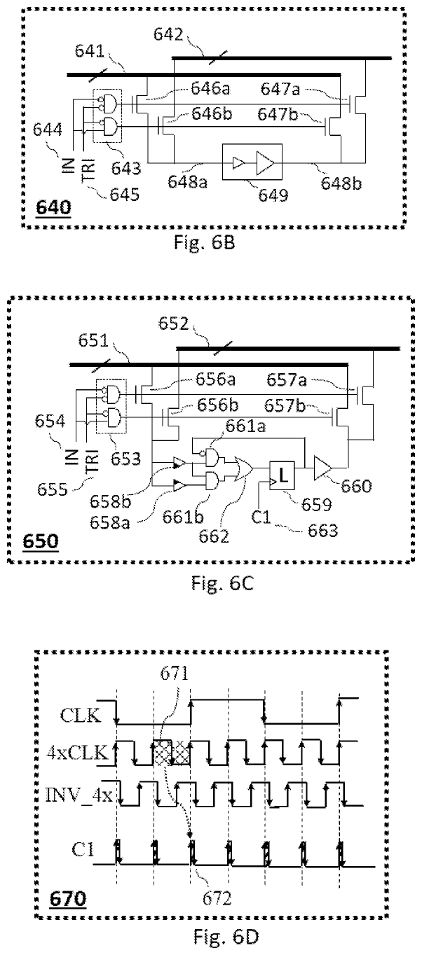

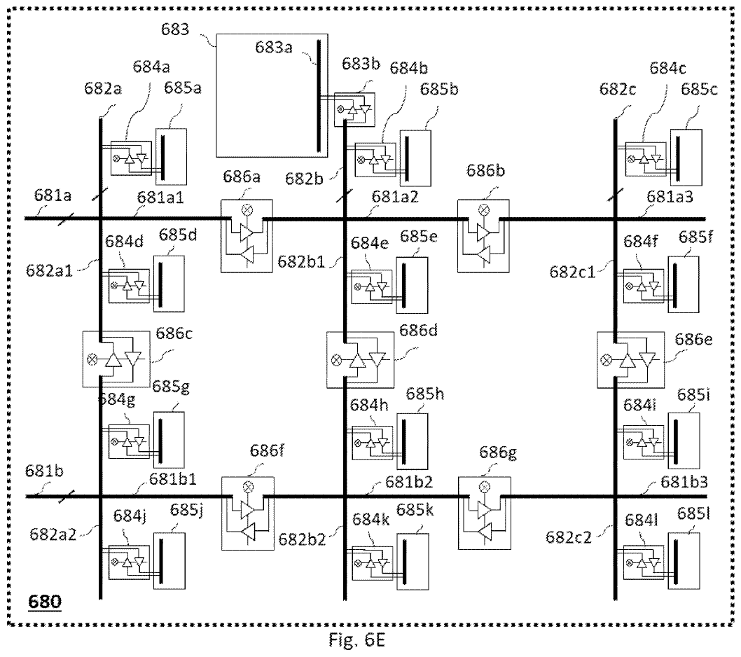

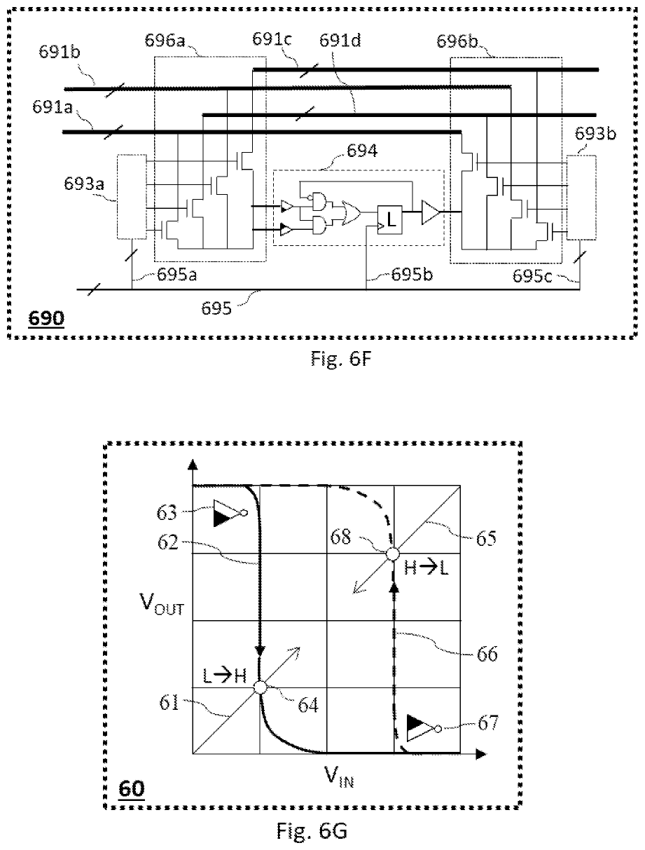

A novel set-associative cache-structure for high bandwidth data access and transfer is shown in 600 of FIG. 6A. A first data address comprises a first tag bits 601, first array address bits 602, a first MSB-mux bit 603, and a first plurality of IO-mux bits 604. A second data address comprises a second tag bits 605, second array address bits 624, a second MSB-mux bit identical to said first MSB-Mux bit 603, and a second plurality of IO-mux bits identical to said first plurality of IO-mux bits 604. Two physical memory structures (left structure and right structure) are addresses by the two data addresses. Second tag 605 comprises an offset from said first tag 601, the offset determined by a software defined memory allocation displacement in paired memory data. The offset is zero to specify the same memory content. Second array address bits 624 comprises an offset from said first array address bits 602, the offset determined by a software defined memory allocation displacement in paired memory data. The offset is zero to specify the same virtual memory content, positioned in two separate physical memory structures. Both physical memory structures share the lower order address bits 603 & 604, wherein 603 is the MSB bit in big-endian definition. In the example in 600, MSB bit 603 is the 4^{th} bit: the IO-decoding comprised of a 3-bit IO-mux 613 & 1-bit MSB-mux 618. Address 602 received by first array mux 611a decodes the input to selects a plurality word-lines 612a having the same address 602, constructed in two separate physical memory arrays, each array similar to 396 in FIG. 3C (imagine two arrays 396 stacked one on top of the other served by same input mux and driver 385, having two separate word-lines 383 one behind the other, and equal number of bit-lines 382 coupled to each word-line 383). The plurality of word-lines (of cache-lines in a first physical array. In 600 of FIG. 6A, the two memory arrays are shaded in different colors. Each selected word line 612a selects a plurality of bit lines. From the simplified drawing, let's assume a 4-bit cache-line denoted [00, 01, 10, 11] actually represents a byte (not a bit). By visualizing each bit position as a byte of data, each word line can be visualized as a 4-byte cache-line. Tag bits are appended to WL as extra bits for each cache-line. In 600, bits yz in 604 reflects byte decoding of cache-line of 4-bytes, the address containing words [yz000, yz001, . . . , yz111] for each of the four yz byte values. Bits xyz is used in 604 to demonstrate there may be 8 B in a cache-line [xyz000, xyz001, . . . , xyz111]. For 64 B cache-lines we would need [xyz000000, xyz000001, . . . , xyz111111]. Cache array 600 is capable of reading or writing at least 1-byte of data into the cache structure. Mux 613a selects one byte from two 612a word-lines in the two arrays having identical xyz bits. Mux 616a is used to match the TAG 601 settings in each of the two selected bytes, to identify a single byte 617a in the left-half cache structure. The tag offset in 605, and array address offset in 625 identifies a different address 612b from address mux 611b; and together with identical 613b xyz decoding allows the offset-TAG matching in 616b to select byte 617b. Am MSB-mux 618 (using bit 603) is used to select 1-byte of data to be sensed in sense-amp 619, latched in latches 620 and outputted by drivers 621. The MSB-mux allows decoupling left-array half and right-array half from the sense-amp 619 to facilitate very fast sensing and clocking of data. Mux 618, sense-amps 618, latches 620 and I/O circuitry 621 is described in detail in FIG. 4A. Write mode is not shown in FIG. 6A. In SDR mode, 600 is able to read and write 1-word at a time in a single cache-line. In DDR mode, 600 is able to read and write 2-words in parallel; the two words offset by a known MSB-defined difference, but sharing common lower order bits. Such shared common lower order bits are the norm in cache structures that access bytes, words, cache-lines and pages. The easiest offset to implement is “1”, meaning two consecutive cache-lines are easily accessed via the left half and right half of physical memory structures. The fast sense in 619 allows for two consecutive data reads in DDR-mode to get twice the data in opposite CPU clock cycles. When the cache memory is close to the input registers, meaning the mesh delay is short, a single bus can couple the DDR-mode to its destination. Clock phasing has to be carefully managed when both clock phases are used to capture data to ensure data accuracy. Comparator logic in 623a & 623b receive TAG bits 601 & 605 over buses 607 & 606 respectively to ensure address match. Memory outputs 614a & 615a are TAG 601 matched in MUX 616a to generate output 617a. Memory outputs 614b & 615b are TAG+OFFSET 605 matched in MUX 616b to generate output 617b.

The illustration 600 in FIG. 6A only show a read path at the outputs 622 with latches 620 & drivers 621. It comprises a write path that is not shown, as previously described in FIGS. 3, 4 & 5. Therefore ports 622 can be visualized as Input/Output (I/O) ports to memory 600. In a first embodiment, I/O 622a and 622b couple to two buses. In a second embodiment, each of I/O 622a and 622b couple to separate one-half of the wires in the same bus. In a third embodiment, I/O 622a and 622b couple to the same wires in the same, the coupling gated by non-overlapping clock phases. In another embodiment both read and write paths comprise latches. In yet another embodiment both read and write paths share a common set of latches, the latches facilitating latch-buffered data transfer to increase data bandwidth.

Consider a wire of length L driven by an output driver such as 621a in FIG. 6A. Let us define the wire length starting at driver end as a variable x. Then x=0 defines the driver end of the wire, and x=L defines the end point of the wire, the end point usually coupled to a capacitive circuit node, such as a gate of one or more transistors. The current flux at x=L is zero, as there is no conduction path to or from a capacitive node. Consider the wire at v=0 at t=0, that has registered a V=0 at the x=L node. We wish to drive a signal ONE starting at t=0, using the buffer switching from an output state zero, to output state one. A very strong driver can be approximated in two ways: a constant voltage source, or a constant current source. The constant voltage source is easier to demonstrate and discuss to show the salient features of how the wire carries the v=V signal from x=0 to x=L, where we are interested in the signal transient delay, aka the wire delay. The voltage in the wire at position x, at time t is given by the variable v(x,t), this voltage is described by a set of equations exactly analogous to heat transfer in a conductor to describe Temperature T(x,t). This Sturm-Liouville problem, with given initial and boundary conditions has an exact eigen-value summation solution:

$$v ( x , t ) = V - \frac{4 V}{π} {\sum }_{n = 0}^{∞} \frac{1}{( 2 n + 1 )} Sin ( \frac{( 2 n + 1 ) π}{2 L} x ) Exp [ - {( \frac{( 2 n + 1 ) π}{2 L} )}^{2} \frac{t}{rc} ] \qquad EQ ( 1 )$$

In EQ-1, r=wire resistance per unit length, and c=wire capacitance per unit length. In 3 nm copper interconnect process technology, r˜15 Ω/μm, c˜0.2 fF/μm, and rc˜3 pSec/μm. Due to the n² dependence in exponential temporal decay of eigen functions, only the n=0 eigen function contribute to the dominant term in wire delay. Keeping only the n=0 term, EQ (1) becomes:

$$v ( x , t ) ∼ V - \frac{4 V}{π} Sin ( \frac{π}{2 L} x ) Exp [ - {( \frac{π}{2 L} )}^{2} \frac{t}{rc} ] \qquad EQ ( 2 )$$

Wire delay is determined by the time it takes for x=L end point of the wire to reach a V_{TRIP} voltage level needed to capture the signal in a latch, typically an inverter input trip voltage level. From EQ (2), at x=L, v=V_{TRIP}, we can extract the wire delay as:

$${t}_{DELAY} ∼ ( \frac{4 {rcL}^{2}}{{π}^{2}} ) Ln ( \frac{4 V}{π ( V - {V}_{TRIP} )} ) \qquad EQ ( 3 )$$

EQ (3) shows the L² dependence in wire-delay. A wire ½ as long will reach V_{TRIP} voltage in ¼ t_{DELAY} of time. For symmetric rise and fall wire delays, V_{TRIP}˜V/2, and t_{DELAY}˜0.38rcL². For L=100 μm long wire, t_{DELAY}˜45 pSec. Compared to a single wire of length L, a midpoint buffered wire has a sum wire delay t_{WIRE}=½ t_{DELAY}+t_{BUFFER}, where t_{BUFFER} is the buffer gate delay. Buffers needs direction, bidirectionality requires configurability and direction.

A configurable bidirectional buffer 640 to improve wire delays is shown in in FIG. 6B. It comprises two ports 641 & 642, an input port and an output port, at the point of buffering, and is configurable to select the signal buffering direction. The buffer can be tri-stated to de-couple the input and output ports. Input-output port definitions change with logic 643 based on configuration or control signals IN 644 and Tristate 645. When TRI 645=1, the two ports are decoupled. When TRI=0, IN=1, port 642 is signal input, and port 641 is signal output. When TRI=0, IN=0, port 641 is signal input, and port 642 is signal output. Ports 641 & 642 may be an internal break-point in a wire, or two end points of two wires in a segmented bus architecture, to buffer and drive a signal arriving on one wire to the other wire. Buffer 649 receives input 648a and generates buffered output 648b. A bus is a plurality of such wires. A first stage of the buffer 649 has a trip-point V_{TRIP} to determine a rising or a falling signal, and a driver to boost the signal in the second segment acting as a near constant current or a near constant voltage source. Configurable paths 646 determine input-port, and configurable path 647 determine output-port. Letters a, b in 646 & 647 denote two configurable paths. When an MMU and control-unit transfer data between a memory unit and the CPU, generated control signals select directionality of data transfer. Tri-state ability allows multiple segments in a segmented interconnect mesh to simultaneously transfer data parallel to improve mesh utilization. The trade-off is extra buffer area to gain better wire delays and higher data bandwidth.

A configurable tristate latch buffer 650 in FIG. 6C is able to detect signal change faster to improve wire delays. Circuitry 653, buses 651/652, gates 566/657 and driver 660 are similar those in 640 of FIG. 6B. Consider TRI=0, IN=0, and bus 651 is the input, and bus 652 is the output. Input 651 reaches two input-detect devices 658a and 658b. In a simple construction, they are inverters (provided the logic is adjusted to get the correct signal polarity at the end). Detector 658a is a high 1→0 detect device, meaning it has a V_{TRIP}>½V, a high-trip point V_{TH}. When the input signal is falling, it trips 658a at V=V_{TH}, thereby lowering the wire delay t_{DELAY} to detect the change. Detector 658b is a low 0→1 detect device, meaning it has a V_{TRIP}<½V, a low-trip point V_{TL}. When the input signal is rising, it trips 658b at V=V_{TL}, thereby lowering the wire delay t_{DELAY} to detect the change. Such circuits are built by ratios in pull-up and pull-down current strengths in an inverter: a strong pull-up with a weak pull-down generates a V_{TL} device; and a weak pull-up with a strong pull-down generates a V_{TH} device. Frequently threshold voltage (Vt) is modified to make devices strong or weak: a low Vt makes it stronger, and a high Vt makes it weaker. When the latch has previously stored a 1 or a 0, the state is unchanged if the input remains at V>V_{TH} or at V<V_{TL} respectively. Both detectors 658a & 658b detect the 1 or the 0. A 1→0 input signal transition, the latch 659 having a previous output 1, is detected early in AND logic 661b when input level in 658a drops to V_{TH}. A 0→1 input signal, the latch 659 having an output 0 previously, is detected early by AND logic 661a when input level in 658b rises to V_{TL}. By V_{TH}/V_{TL} trip point settings in detectors 658, for a common input, 658a output=1, and 658b output=0 cannot occur simultaneously. The OR logic 662 combines to two early detect input signals to latch into latch 659 by a positive edge triggered clock C1 663. As it is +ve edge triggered, only the previously stored latch 659 output value at triggered edge contribute to the new captured signal. There is one latch per wire. The clock is common to all latches in the bus. In FIG. 6C, 654 & 655 are input and tri-state signals; 656a,b & 657a,b are pass-gates. The edge-triggered clock is shown in FIG. 6D. Original CPU clock is shown as CLK, and a 4× clock is shown as 4×CLK which comprises 4 clocks within 1-CLK period. INV_4× is a 4×CLK followed by an inverter, the 4×CLK signal is inverted and delayed by the inverter gate-delay. This gate delay can be increase by adding capacitive elements. C1 clock is generated by AND logic of the 4×CLK signal and INV_4× signal. It comprises +ve pulses at 4×CLK +ve edges, the pulse width equaling the inverter gate delay in INV_4×. A signal transmitted in the bus during 4×CLK pulse 671, is captured by the latch at C1 edge 672, and the captured data is transmitted in the output bus in the immediately following 4×CLK cycle. The latency is one 4×CLK cycle, but data transfer rate is 4×CLK cycle frequency. At every 4×CLK value, the latch value gets re-written with the new data. Latches facilitate synchronizing clocks across a large mesh, and keeping track of the data transfer latencies. In the example in EQ (3), for high V_{TRIP}=V_{TH} in detecting the 1→0 signal quickly, using (V−V_{TH})=¾V we get t_{DELAY}˜0.21rcL² (at ½V trip point it was 0.38rcL²). For L=200 μm long wire, t_{DELAY}˜25 pSec. This is a 1.77× reduction in data transfer wire delay time. Conversely, for the same wire delay, we can use 1.33× (L=266 μm) longer wires to reduce the total number of latched buffers needed.

A segmented high bandwidth bus interconnect mesh 680 is shown in FIG. 6E. The mesh 680 comprises horizontal bus 681a & 681b, each further comprising segments 681a1-a3 & 681b1-b3 segments respectively. The mesh 680 comprises vertical bus 682a-682c, each further comprising segments 682a1-a2, 682b1-b2 & 682c1-c3 segments respectively. Segments are configurably coupled by either buffers such as 640 in FIG. 6B, or latched-buffers such as 650 in FIG. 6C. These are shown as buffers 686. Mesh 680 couples an L3$ 683 to a plurality of L2 caches 685 distributed across a die floor-plan to support a multi-core CPU system. Each L2$ 685 may service a plurality of L1$ & FAUs not shown. A read and write port 683a in L3$ 683 couples the L3$ memory array to mesh 680. A read and write port in L2$ 686 couples the L2$ memory array to mesh 680. Both uses latched-buffers 683b & 684 respectively to facilitate multi-phase data clocking from cache memory array to the bus, as previously described. As the mesh is segmented, different segments of the mesh may be used simultaneously to transfer data, thereby improving the mesh utilization. As an example, activate: (684a, 686c & 684j), (683b & 684c), (684c, 686c, 684l); and tri-state the rest: 684b, 684d, 686a, 686b, 684f, 686d, 684g, 686f, 686g, 684h, 684i & 684k. Concurrently, 685a is coupled to 685j, and 683 is coupled to 685e, and 685c is coupled to 685j to transfer data. The mesh can support 3× the bandwidth of a SDR, DDR or QDR bandwidth. This is a very significant benefit in high bandwidth data communication. A first novel feature is that regardless of the driver directionality, the latches and drivers can store drive buffered signals. A second novel feature is that wires can transfer higher data rates compared to memory read or write time in cache-arrays, allowing a single read or write cycle to be accompanied by SDR, DDR or QDR wire data transfers. Prior art FPGA segmented interconnects provide bit level configurability to connect wires. In this novel CPU interconnect segments, the configuration is in Byte-mode (8-wires at once), and preferably in Word-mode (32 to 512 wires or more at a time). This allows a significant reduction in configuration bits needed to program bus interconnect, and facilitate dynamic switching of the small number of configuration bits. This novel Bit-Byte configurability is further disclosed in the incorporated by reference disclosures.

A novel feature in high throughput data bandwidth is in the capability of simultaneously using a segmented bus architecture comprising configurable switch boxes that allow bus connectivity and signal direction to be assigned dynamically. A configurable interconnect bus structure 690 is shown in FIG. 6F. It comprises four buses 691a-691d. A signal arriving in any one of the buses can be buffered and driven out in any of the remaining 3 buses. The latched-buffer driver 694, described in 650 of FIG. 6C, comprises early detection trip sensors, a multiphase clock input 695b to latch incoming data, a driver to buffer the signal and drive it onto a selected output bus. Switch box 696a is configured to select one of the input buses via logic in 693a receiving a plurality of control signals 695a. Chosen bus couples to input in 694, and it comprises a tri-state condition to isolate the latched-buffer 694. Similarly, switch box 696a is configured to select the output bus via logic in 693b receiving a plurality of control signals 695c. It can select one of the buses to couple to input in 694, or tri-state all busses. The coupling structure couples a first input data bus to a first output data bus. Structures 693a, 696a, 694, 696b & 693b are duplicated to form a second parallel latched-buffer driver, the second coupling structure identically coupled to the same four buses. The second coupling structure couples a second input data bus to a second output data bus. This cross point 690 could exist at the intersection of a vertical bus 682b1 and a horizontal bus 682a2 in segmented bus 680 of FIG. 6E to facilitate memory 685b to couple to be routed to driver 686a, while simultaneously driver 686b may be coupled to memory 684c to improve the efficiency of mesh data bandwidth. Configurable segmented bus architecture improves cache data transfer between memories by allowing parallel data transfers.

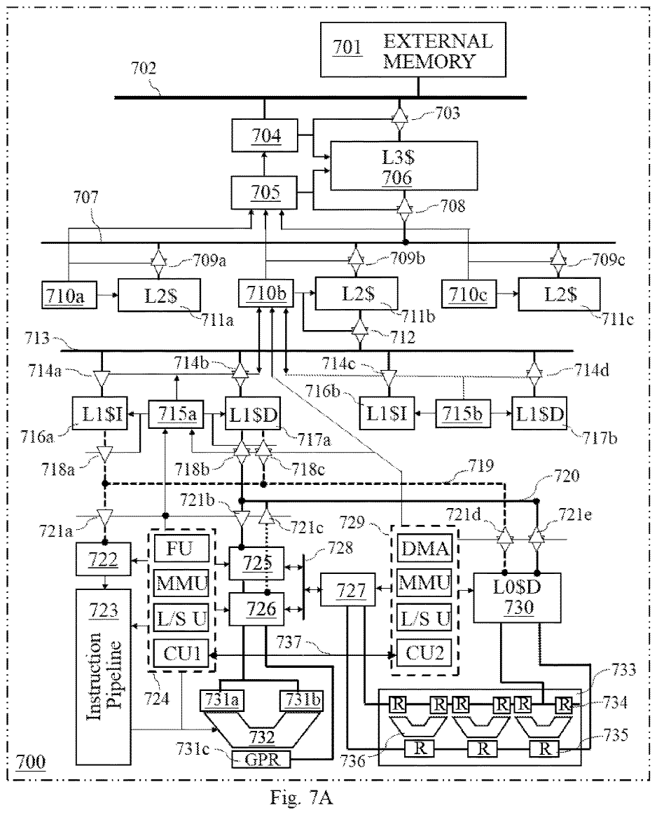

A plurality of distributed L2$ memory 685 blocks couple to each other, and to L3$ 683 via the configurable bus interconnect 680 in FIG. 6E. External data received by L3$ can be distributed and stored in the plurality of L2$ 685 caches. This is a significant expansion of L2$ cache memory in the memory hierarchy: a CPU in a local L2$ domain can look for missing data in other L2$ caches. This facilitates a novel cache memory hierarchy for CPUs over prior art by enhancing L3$ 683 to read/write dual port memory (a smaller memory array as dual port memory is expensive) for simultaneous data transfer with I/O processor (704 in FIG. 7A) to enhance external communication bandwidth, while using distributed L2$ 685 to increase the total on-chip memory storage to improve concurrent parallel memory access and compute data bandwidth.

Voltage transfer curves for early input transition detector circuit comprising dual V_{TL} & V_{TH} trip point inverters is shown in 60 of FIG. 6G. It comprises two inverters 63 and 67. During a low to high signal transition 61, abbreviated as L→H, output 62 of the inverter 63 transitions from H→L, and the transition trip point 64 is determined by pull-up PMOS and pull-down NMOS transistor strengths in the inverter 63. To have a low V_{TL}. 64 value, in inverter 63, NMOS has a low-threshold voltage, PMOS has a high-threshold voltage, and NMOS has stronger drive current. For V_{DD}=0.75 volt power supply voltage, V_{TL} is <V_{DD}/2, preferably <0.25 (⅓V_{DD}) volts, and more preferably ˜0.15 (⅕V_{DD}) volts. The wire signal is detected as a 1 when the input voltage has risen from 0 v to 0.15 v for early detection in rise time. Similarly, a second inverter 67 detects an input 65 falling transition H→L to generate output signal 66 by inverter 67. To have high trip point 68 in inverter 67, NMOS has a high-threshold voltage, PMOS has a low-threshold voltage, and PMOS has stronger drive current. For V_{DD}=0.75 volt power supply voltage, V_{TH} is >V_{DD}/2, preferably >0.5 (⅔V_{DD}) volts, and more preferably ˜0.60 (⅘V_{DD}) volts. The wire signal is detected as a 0 when the input voltage has fallen from 0.75 v to 0.60 v for early detection in fall time. Early detection in both direction is achieved at an extra cost in Silicon area. High threshold & low threshold transistors are standard in all process technologies used to fabricate ICs. Dual inverter circuit 60 has 3 states for output voltage V_{OUT} based on input voltages V_{IN} ranges. (i) 0<V_{IN}<V_{TL}, V_{OUT,63}=1, V_{OUT,67}=1. (ii) V_{TL}<V_{IN}<V_{TH}, V_{OUT,63}=0, V_{OUT,67}=1. (iii) V_{TH}<V_{IN}<V_{DD}, V_{OUT,63}=0, V_{OUT,67}=0. A novel feed-back technique uses previously stored latch value to recognize which of the inverters define the next latch state transition. When the latch has a stored value “0”, we look for an early L→H transition, and inverter 63 (equivalent to 658b in 650 of FIG. 6C) is used to latch next data with Boolean logic 661a in 650 (input signal polarity in 661a needs to be adjusted when 658b is an inverter). When the latch has a stored value “1”, we look for an early H→L transition, and inverter 67 (equivalent to 658a in 650 of FIG. 6C) is used to latch next data with Boolean logic 661b in 650 (input signal polarity in 661b needs to be adjusted when 658a is an inverter). Early rise and fall detection in segmented interconnect facilitate insertion of periodic latch-buffers such as 650 & 690 to significantly improve the frequency at which data is transferred. The latency is known by counting latch-buffers between end points. These novel embodiments disclosed together with realistic industry 3 nm fabrication wire RC time constants show that we can realize 10×-100× higher data bandwidth over prior-art. As described by EQ (3), an early detect L→H trip point change from ½V_{DD} to ¼V_{DD} improves wire transfer delay by 1.8×. Similarly, an early detect H→L trip point change from ½V_{DD} to ¾V_{DD} improves wire transfer delay by 1.8×.

An embodiment of a novel high bandwidth macroprocessor micro-architecture comprising a coherent cache memory hierarchy and a pipelined accelerator is shown in 700 of FIG. 7A. It illustrates how a high band width CPUs such as 500 & 550 in FIGS. 5A & 5B respectively are coupled to an external memory in a coherent cache memory hierarchy. A CPU system interacts with an external (outside of the CPU chip) memory 701 using an external motherboard (PCB) bus 702, using an input/output processor (IOP) 704. Memory 701 includes one or more of: SDRAM, DDR-DRAM, HBM-DRAM, Flash and Disk-Drive storage. Memory 701 is arranged in 4 KB pages (or 8 KB pages, a pre-arranged page-size known to the operating system OS), and an OS allocated memory address space stores a fully detailed physical page-table of the memory content in the external memory device. Large memories store tera-bytes of data. Data is retrieved or stored one or more pages at a time, a change in data storage updating the resident page table. External memory to L3-cache data transfer is discussed first. Based on CPU commands, IOP 704 fetch or stores data between memory 701 and L3-cache (L3$) 706, a memory management unit (MMU) 705 engaging the IOP 704 activity. A bidirectional high data rate driver 703 manage the data transfer, engaging a variety of data communication protocols such as USB, DDR, QDR, XP-IO etc. Only a limited set of pages are present in L3$ 706, and a translation lookaside buffer (TLB in 4 KB page addressing) maintains an address translation between the virtual-address assigned for pages stored in L3$ 706 and the full address page table stored in memory 701. Two events trigger an IOP 704 data transfer by MMU 705, a TLB cache-miss, and an L3$ 706 page-eviction. In L3$ 706, old memory data must be saved when evicted, new memory data must be fetched on a cache-miss, and TLB updated in both cases. L3-cache to L2-cache data transfer is discussed next. A plurality of L2-caches (L2$) 711 requests data from L3$ 706. Each L2$ 711 is coupled to its own MMU 710. An L2$ 711 coupled MMU 710 requests data from L3$ MMU 705. Using a bus 707, and a plurality of bidirectional tri-statable drivers 708 & 709a,b,c a specific L2$ is selected to transfer data to or from L3$ in 4 KB pages. L2$ to another L2$ data transfers may also utilize the bus 707, and data transfer can occur from one source to a plurality of destinations on the same bus concurrently. Bus 707 comprises a mesh shared by all L2$s that spans an entire chip for multi-core CPU systems. These buses can span 10-25 mm in length, and have long wire RC-delays˜500 pSec-1 nSec. R is the resistance, and C is the capacitance of a wire. Bus 707 comprising 2048 wires operating at a frequency 1 GHz (assume wire delay 1 nS) transfers 256 GB/sec of data. In a bus wire of length L, the wire resistance and capacitance scale with the length dimension, and RC-delay is ˜rcL², where r=resistance per unit length, and c=capacitance per unit length. When the length is reduced by 2×, the RC-delay is lowered by 4×; the new wire RC-delay˜125-250 pSec compared to 1 nSec previously. In a preferred arrangement, bus 707 comprises buffered-drivers at half-way points (not shown), so that an L3$ 706 to L2$ 711a will first move to an intermediate driver or a storage-buffer 706a (not shown) and then move from buffer 706a to L2$ 711a. The mid-point buffers will provide 4× data transfer time reduction per ½ segment, for an overall 2× time reduction at the destination of L2$. Due to buffer overhead delays, improvement may be ˜1.5× faster. The overhead area penalty may not quite justify the benefit. A more useful benefit is, as shown in FIG. 3, a 4× lower RC-delay may facilitate using DDR or even QDR mode of data transfer from its SDR data transfer rate. For the moment, let's assume QDR-transfer from L3$ to a storage-buffer 706a (not shown, at mid-point between 706 and 711a). 4 GHz, 2048-wire bus data transferer rate improves to 4×4×(2048/8) GB/s=4 TB/s in each ½ data transfer step, for an overall 2 TB/s theoretical data bandwidth. Even when there is a buffer overhead penalty, L3$ to L2$ data transfers can exceed 1.5 TB/s (compare with 256 GB/s) with this innovation. L3$ is very large, and scales with total CPUs in a multi-core SOC. In a preferred embodiment, a 48 CPU-core superscalar of this novel high bandwidth CPU architecture comprises 120 MB of SRAM cache. L3$ construction can be visualized as one of 300, 340 and 380 shown in FIGS. 3A, 3B & 3C respectively, where the bus 707 is split into two equal halves, bus 717a and bus 707b. First, combining FIG. 3A with FIG. 6A, two pages at an “offset” address difference can be transferred between the L3$ 706 and two different L2$ 711 caches, one page on 707a (1024-bits/CLK) and the other page on 707b (1024-bits/CLK) at ½ the bus 707 transfer rate. In this mode, both data transfers can be read, or write or a mixed one-read & one-write due to having two separate physical memories at both ends. A 4 KB block of data may be transferred in 2 KB chunks to two destinations, provided page-tables can accommodate ½ page addresses, to reduce latencies in data transfers. Using offset between two addresses is especially useful in page transfers as all pages are physically byte aligned in caches, and two-pages are separated by a fixed higher order significant bit offset between the two. In labels, ending letters denote multiple instances.

In turn, each L2$ 711 supports a plurality of L1-caches (L1$), each L1$ further divided into an I-cache (L1$I) 716 and D-cache (L1$D) 717. L2$ to L1$ coupling share a common bus 713, and data transfer is in 4 KB-pages. A 2 KB page size is more advantageous to reduce page transfer latency. Each L1$ has a unique MMU 715 to handle data requests. Tri-statable bidirectional drivers 714 facilitate data transfer between a unique L1$I 716 or L1$D 717 and the common L2$ 711b using shared bus 713 via tri-statable driver 712. For I-cache, data transfer via 714a or 714c is unidirectional, instructions are only read, never altered and written-back. In the event L1$ MMU 715a requests a data transfer between L2$ 711b and L1$I 716b, all other communication paths (714a, 714b, 714d) are tri-stated, and only the incoming path from L2$ 711b to L1$I 714c is activated by MMU 710b; each of the CPU MMUs 715a and 715b requests to MMU 710b are synchronized and orchestrated in this selection. Data can be transferred between two L1$ caches 717a & 717b sharing the same bus 713. MMU 710b is further coupled to configurable accelerator (FAU 733) control-block 729 that comprises a direct memory access (DMA) request into L2 MMU 710b to ask for data transfer from L2$ 711b to L1$D 717a when the control unit CU2 in 729 is acting in master-mode (CU1 in 724 is in slave mode). DMA in 729 may request MMU 710b to transfer data between L1$D 717 and L1$D 717a, while MMU 717b will orchestrate that request with MMUs 715a and 715b to ensure data coherency. This will be revisited later. L2$ to L1$ communication bandwidth is a major bottleneck in super scalar computing. At one time, only one L2$ to L1$ (I-cache or D-cache) path can be active. L2$ storage size, L1$ storage sizes, number of CPUs supported by one L2$ (each CPU has its own L1$), number of pipelines (how wide) per CPU, number of parallel threads per CPU, and theoretical compute capacity of CPU is determined by this decision. Data flowing in and out of all CPU-threads must balance the data throughput between L2$ and coupled L1$. Consider one distributed L2$ 710b serving 2 adjacent CPU cores shown by L1$ 716a/717a and L1$ 716b/717b in 700. In 3 nm fabrication technology, Cu interconnect wire delay is 10-20 pico-see/mm, and typical 2-core bus 713 wire length is ˜2-3 mm long. This allows data transfer bus-RC delay times of 30-60 pSec. For a best-in-class 5 GHz CPU frequency, clock-cycle is 200 pSec, half-clock cycle 100 pSec>bus 713 RC-delay. L2$ memory structure is constructed as shown in 600 of FIG. 6A, wherein: latches 620a and 620b latch data in opposite phases of a 5 GHz clock, and MSB-mux 618 address 608 is double-clocked as described by DDR-mode in FIG. 4A, and output drivers 621a & 621b are coupled to a common bus such as 713 in FIG. 7A. Every 5 GHz clock cycle, two data cache-lines are received, doubling the data bandwidth of bus 713 over prior-art. When FAU 733 accelerator operates at 2.5 GHZ (50% of CPU clock) L2$ to L1$ data transfer rate is 4×FAU clock rate, and each of the two FAU 733 accelerators can get L1$D data transfers at 2× the FAU clock rate. When the bus 713 RC-delay is <50 pSec (lower end of the range 30-50 pSec), as described by QDR-mode in FIG. 4A, the data transfer between L2$ and L1$ can be increased 4x over prior-art. For a 512-wire bus 713, operating at 5 GHz clock QDR-mode, the data transfer rate between L2$ 711b and a L1$D 717a can reach 1.28 Tera-Bytes/sec, taking only 3.2 nano-secs to transfer a 4 KB page, and 50 pSec to transfer a 64 B cache-line. It can be doubled to 2.56 TB/s with 1024-wire 713 bus. L2$ to L1$ data transfer makes use of a single bus, as opposed to having two buses as shown in FIGS. 3A-3C. By designing the cache memory for multi-mode caching, taking advantage of low bus-RC delay with latched-buffers to ensure DDR/QDR mode clock-synchronization when and where needed, one can use two-phase or four-phase clocking to double or quadruple data transfer between L2$ & L1$ caches. High band width CPU 700 utilizes a multi-modal memory cache hierarchy, a multi-phase clocking segmented bus interconnect network (segment buffers as shown in FIG. 6E), and configurable direction and tri-state buffering (as shown in FIGS. 6B & 6C) in data paths that ensures timing accuracy and allows in parallel simultaneous data transfers in decoupled different bus-segments.

L2$ to L1$ data transfer is described next. When CPU 732 is processing instructions (called the CPU-mode), instructions are transferred from L1I$ 716a to instruction buffer 722 in 64B cache-lines, and related data is transferred from L1$D 717a to fetch buffer 725, and results stored from store buffer 726 back to L1$D 717a. Buffers 718a and 721a are activated to use I-cache bus 719 for I-data transfer. Buffers 718b and 721b are activated to use D-cache bus 720 to bring D-data into load buffer 725. Buffers 718b and 721c are activated to use D-cache bus 720 to store D-data from store buffer 726. Load and store must share bus 720, and only one operation can occur at any given clock cycle. During CPU-mode, control block 724 acts as master, and control block 729 acts as slave, taking instructions from the master. Control block 724 comprises control a unit CU1, a load/store unit L/SU, a memory management unit MMU, and a fetch unit FU. In a preferred embodiment, four consecutive instructions at a time in instruction-buffer are fetched into an out-of-order (OOO) instruction pipeline (IP) 723 for processing. Instruction pipeline (IP) 723 has a plurality of stages such as decode, rename, etc. (such as 221 in FIG. 2B), each stage engaging control-block 724 to synchronize data transfer and instruction interpreted actions execution. One such sequence of actions is to load data from load-buffer 725 to GPR ports 731a and 731b, execute a specified function in 732 and place the result in GPR 731c, and move the result from GPR 731c to store-buffer 726. In CPU-mode, IP 723 may receive an FAU 733 instruction, a simplified interpretation as the function is pre-programmed into the FAU 733 by firmware. The master control-block passes the instruction along with related data to slave control block 729 to execute that instruction and return the result(s). Input data resides in load-buffer 725 and its associated cache coherent hierarchy. In a first embodiment, from load-buffer, this data is copied to a transfer-buffer 727 using a local bus 728. In a second embodiment, from load-buffer, this data is copied to an L0$D cache 730 using a local bus 728, and the decision may depend on the amount of data to be copied. Since bus 728 is local, it does not affect the cache hierarchy, and does not incur a long latency to transfer data. Control block 729 comprises control unit CU2, a load/store unit L/SU, a memory management unit MMU, and a direct memory address unit DMA. Slave control block 729 execute the FAU instruction directing input data to ports 734, and returning results at output ports 735 back to transfer-buffer 727 (or L0$D 730 if so directed). In FAU 733, 736 is a plurality of configured HW function units. Bus 728 facilitates FAU output result to return to either load-buffer 725 (for re-use by CPU 732) or to store-buffer 726 (to return back to L1$D). It is understood that bus 728 also facilitate data passing from store-buffer 726 to load-buffer 725 to avoid latency penalty in saving the store-buffer data back to L1D$ 717a and re-fetching it back to load-buffer 725. For re-use. Transfer buffer 727 is used to pass parameters between CPU data-path and FAU data-path. Passing parameters back-and-forth between disparate heterogeneous compute techniques is novel. The FAU can process an apriori configured SIMD or MIMD function that would normally take 1000s of CPU-cycles in one or two cycles. The FAU may comprise a DSA function that may take 1000s of CPU-cycles in one or two cycles. It is novel that the result of such a complex DSA accelerator function is instantly available at local CPU compute data domain for reuse, resulting in much higher performance (reduced latency) and lower power (reduced data movement and copy).

CPU 700 comprises an FAU-mode, where control block 724 receives a repeated use of FAU 733. During this mode, control block 724 assigns the master mode to control block 729, and 724 enters a slave mode. This duality in control-unit (block) master-slave assignment is novel in CPUs. The FAU 733 can consume a very large amount of data very quickly. It comprises a very wide input data width: it may be 1024 b wide (64 B), or preferred 2048 b wide (128 B), or even higher. Local L0$D cache is designed to handle this very wide data read & data write. FAU executes 1 cache-line of input data, or 2 cache-lines of input data at a time. During FAU-mode, as previously described, CPU 732 does not require instructions, and master control block 729 puts I-cache 716a to tri-state (or decouple) mode, and assigns the bus 719 by activating buffer 718c for use with L1$D 717a to double the data transfer capability. Not only L1$D has DDR/QDR modes of operation, now it has twice the bus capacity. In the theoretical best case, we have increased the data bandwidth 8× between L1$D and L0$D, a break-thru in CPU computing data bandwidth. For 5 GHZ, 512-wire I-bus & 512-wire D-bus, in QDR mode, the data transfer rate is 2.56 TB/s. For 1024-wire in each bus, this would be 5.12 TB/s. Data movement into load-buffer 725 occurs in a CPU-compute orchestrated manner, and initial block of data, one or more cache-lines, for FAU may reside in 725 (none is assigned to GPRs 731, so that is not a concern), some pages of data may reside in L1$D 717a, more pages may reside in L2$ 711b, and L3$ 706, with some more pages residing in external memory 701. This is the case for model parameters with GPT3-175B model parameter model. FAU-mode must be able to handle large amounts of data transfer. This is facilitated by DMA in control block 729 that works with a local MMU in 729, in conjunction with local MMU in 724. MMU in 724 ensures data coherency by CPU design practices. MMU in 729 interacts with MMU in 724 to adhere to data coherency, recognizing only data-store statements can modify data. When DMA is engaged, both I-bus 719 and D-bus 729 read/write data between L1$D 717a and L0$D 730. First, data in 725 is copied to L0$D 730, the memory address pointers updated to reflect the data fetched. Next block of data is directly retrieved from L1$D 717a to L0$D by the DMA. When the L1$D records a cache-miss (runs out of data), the DMA communicates the cache-miss to L2$ 711b MMU 710b. This can be done exactly as how a cache-miss is communicated by MMU/CU1 in CPU control block 724. It can be directly or via MMU/CU1 in 724. In a preferred embodiment, the DMA can communicate this through the CPU-MMU/CU1 in 724. MMU/CU1 initiating cache-miss service for FAU accelerator data is a novel feature in this data flow architecture, thereby ensuring cache coherency when FAU is in use, which is another novelty in this method. To the author's knowledge, this is the first time that a CPU pipeline can compute DMA accelerator functions within its own existing cache coherent infra-structure. It is data-write that must prevent mis-match in different copies of identical data when updated. MMU/CU1 in 724 has built in coherency infra-structure to ensure this. Once DMA/CU2 in 729 store compute results from L0$D 730 to L1$D 717a, it informs the MMU/CU1 in 724 to initiate data retire to use existing CPU infrastructure to continue data storage in the cache hierarchy. This is a novel feature in this high bandwidth data flow architecture.

CPU 700 comprise a hybrid-mode of operation, wherein both CPU-mode and FAU-mode may be active in very short intervals. During this mode, the master-slave behavior between the two control blocks inter-change, the master always initiating the role change. During the hybrid-mode both instructions and data must arrive in bursts as needed, the I-bus 719 bringing instructions and D-bus 720 bringing data. Due to the dynamically configurable tri-state capability of bus drivers/buffers, the bus allocation can be altered dynamically by the control units CU1 & CU2 since data transfer occurs in burst time intervals of transfer page at a time. CU1 interacts with CU2 over bus 737.

Prior art CPUs do not offer gate definitions and gate level connectivity, and they do not construct hardware features. They simply select pre-defined hardware features to facilitate micro-operations in a cyclical sequential manner. Inability to create atomic actions, having to generate repeated cyclical micro-operational control signals, have significantly hampered CPU compute capability metrics over the past 60-years. The von-Neumann bottleneck refers to the instruction processing restriction in CPUs that limit state-of-the-art super scalar IPC to exceed ˜3. What is described is a novel CPU architecture that overcome von-Neumann & Harvard architectural limitations in instructions processing to improve power, performance, compute-density and data throughput. Simplifying ISA-instructions may restrict backward compatibility with existing software code. Increasing ISA (such as in co-processors) requires new compilers and user learning, making adoption difficult. New CPU architectures must use existing industry standards to leverage the vast design community knowledge and experience in using standard tools. Change must appear transparent to the user, such as using new drivers in hardware that appear transparent to users. Augmenting Harvard-like architectures must appear transparent to the user. Enhancements to controller unit to achieve that must also appear transparent to user, further offering power, performance, throughput and efficiency advantages to users. CPU 700 achieves these goals.

Although an illustrative embodiment of the present invention, and various modifications thereof, have been described in detail herein with reference to the accompanying drawings, it is to be understood that the invention is not limited to this precise embodiment and the described modifications, and that various changes and further modifications may be effected therein by one skilled in the art without departing from the scope or spirit of the invention as described in this disclosure document.

What is claimed is:

1. A computer processing unit (CPU) for high bandwidth data processing comprising an instruction bus to transfer instruction-data and a data bus to transfer compute-data, comprised of:
a configurable first mode to transfer instruction-data in the instruction bus, and transfer compute-data in the data bus; and
a configurable second mode to transfer compute-data in both of said instruction bus and said data bus.

2. The device of claim 1, wherein the data bus comprises a plurality of wires, and the instruction bus comprises the same or a higher number of wires as the data bus, and wherein:
the configurable first mode transfers compute-data at a first data rate; and
the configurable second mode transfers compute-data at a data rate higher than the first data rate.

3. The device of claim 1, further comprising:
an instruction processing unit; and
an accelerator unit to process a function instruction; and
a configurable means comprised of:
interpreting a received instruction to determine the configurable mode; and
configuring the configurable first mode to use the instruction processing unit and the accelerator unit for data processing at the first data rate; and
configuring the configurable second mode to halt transferring instruction-data and use the accelerator unit for data processing at a data rate higher than the first data rate.

4. The device of claim 3, further comprising:
an instruction cache memory configurably coupled to the instruction bus; and
a data cache memory configurably coupled to the instruction bus and the data bus; and
a first control unit, and a second control unit; and
the configurable means comprised of:
configuring the first mode to assign the first control unit to a master control role, and assign the second control unit to a slave control role controlled by the master, and couple a portion of the instruction cache memory to the instruction bus, and couple a first portion of the data cache memory to the data bus; and
configuring the second mode to assign the second control unit to the master control role, and assign the first control unit to the slave control role controlled by the master, and decouple the instruction cache memory from the instruction bus, and couple the first portion of the data cache memory to the data bus and a second portion of the data cache memory to the instruction bus.

5. The device of claim 3, further comprising:
two or more memory buffers; and
a first plurality of compute-data forming a first word comprised of one or more consecutive bytes of data; and
a second plurality of compute-data forming a second word comprised of consecutive bytes identical to the first word; and
the configurable second mode further comprised of:
a load mode to transfer the first word in the first bus, and transfer the second word in the second bus from the data cache memory to a said memory buffer; and
a store mode to transfer the first word in the first bus, and transfer the second word in the second bus from a said memory buffer to the data cache memory.

6. The device of claim 4, wherein the configurable means further comprising a means for the master control unit to change the configurable modes between the master mode and the slave mode.

7. The device of claim 5, wherein:
during the first mode, the CPU receives instruction-data from the instruction cache memory, and compute-data from the data cache memory to concurrently execute a plurality of instructions in the instruction processing unit, and execute a function instruction in the accelerator unit; and
during the second mode, the CPU receives compute-data in the instruction-bus and the data-bus from the data cache memory to increase data bandwidth for a plurality of successive function computations in the accelerator unit.

8. A high bandwidth cache memory structure in a computer processing unit (CPU) comprising:
a first clock cycle time to access a cache memory array to transfer two or more data words, each data word comprising an identical plurality of data bits; and
a first bus comprising a plurality of wires, the number of data bits in the data word identical to the number of wires in the first bus to transfer a data word; and
a first address to select a word line in an array of memory elements, the word line comprising memory elements of at least a first and a second data word; and
a second address to select one of the first and the second data words; and
a first configuration to couple one of the first and the second data words to the first bus, and dynamically switching the second address at least two times within the first clock cycle time to transfer the two data words sequentially in the first bus.

9. The device of claim 8, further comprised of:
a second bus comprising a plurality of wires identical to the first bus; and
a second configuration to:
couple the first data word to the first bus; and
couple the second data word to the second bus, independent of at least one address signal status in the second address;
wherein, selecting the first and second addresses couple the first and the second data words simultaneously to the two buses to transfer two data words during the first clock cycle.

10. The device of claim 8, wherein:
the first address selects 2^{N} data words where N is an integer greater than one; and
the second address comprises N address signals to couple one of the 2^{N} data words to the first bus, and dynamically incrementing the second address N times within the first clock cycle time transfers 2^{N} data words sequentially in the first bus.

11. The device of claim 10, further comprising:
a bit line to output each data bit value of 2^{(N+M)} bit line outputs comprising the selected 2^{N} data words, each said data word comprising 2^{M} data bits, where M is an even integer; and
the first bus comprising 2^{M} wires to transfer a data word comprised of 2^{M} data bits; and
a said bit line includes a first RC time constant to reach a detect voltage from the time the word line is selected; and
a sense device comprising an output node coupled to a said wire in the first bus, and an input node comprised of:
a means to selectively connecting to a bit line in each of the 2^{N} data words; and
a second RC time constant to reach a voltage nearly equal to the detect voltage from the time the input node is connected to a bit line, wherein the second RC time constant is at least 2^{(N+1)} times lower, and preferably 100 times lower, and more preferably 1000 times lower than the first RC time constant;
wherein, dynamically incrementing the second address connects one of said 2^{N} data word bit lines one by one to the sense device input node to detect and transfer 2^{N} data bits in the first bus during the first clock cycle time.

12. The device in claim 11, further comprising:
each sense device comprised of 2^{N} latches, each latch comprising: an input; and an output; and a latch capture time less than the second RC time constant; and
a selectable means of coupling the sense device output to each of the 2^{N} latch inputs one at a time matched with the dynamic incrementing of the second address to capture the detected 2^{N} bit line values in the 2^{N} latches; and
a driver comprising an input and an output that buffers the input signal; and
a selectable means of coupling the 2^{N} latch outputs one at a time in 2^{N} time steps to the driver input during the first clock cycle time to relay the latched data at the driver output coupled to a bus wire to increase the data transfer bandwidth by 2^{N} times.

13. The device in claim 12, further comprising:
the first address selecting 2^{N+1} data words comprised of a first set of 2^{N} data words, and a second set of 2^{N} data words; and
a first set of 2^{N} latches to capture the first set of 2^{N} detected data words; and
a second set of 2^{N} latches to capture the second set of 2^{N} detected data words; and
a second bus comprising 2M wires identical to the first bus wires; and
the second address comprising (N+1) address signals; and
a second configuration to selectively couple first word bit lines to the first set of latches, and the second word bit lines to the second set of latches during dynamically incrementing N address signals regardless of at least one address bit in the (N+1) bit second address;
wherein, coupling the first set of 2^{N} latched outputs in the first bus wire, and the second set of 2^{N} latched outputs in the second bus wire, one pair at a time in 2^{N} time steps sequentially increase the data transfer bandwidth by 2^{(N+1)} times.

14. The device of claim 12, wherein the first bus further comprises a segmented interconnect structure comprising:
a first wire segment comprised of a first end coupled to a said driver output comprising:
a means of by passing the driver and coupling to a said bit line; and
a wire segment length; and
a second end capable of coupling to a second wire segment of equal segment length to relay a signal utilizing a bidirectional latch buffer comprised of:
an input to receive the signal and an output to relay the signal; and
a configurable means of selecting the input and the output to couple to the first and second wire segments to configure the signal direction; and
a detector coupled to the input to detect an input signal transition comprising a trip-point; and
a latch coupled to the detector to store a binary data value based on the transition detection, the latched value buffered at the output to relay the signal;
wherein, the wire segment length and the trip-point facilitate achieving a wire segment delay 2^{N} times lower than the first cycle time to transfer high bandwidth memory data.

15. A sense device to evaluate a data state of a memory element in a cache memory structure of a computer processor unit (CPU), the sense device comprising:
an input node comprised of a first capacitance; and
a configurable means to couple the input node to a plurality of bit lines in a memory array, each bit line having a second capacitance, the configurable means comprising:
a first state to isolate the input node from the plurality of bit lines; and
a second state to connect the input node to a said bit line to detect a voltage level of the bit line determined by a data state in a memory element coupled to the bit line by an address selected word line; and
a plurality of cyclical isolate and connect operations for the input node to connect to the plurality of bit lines one by one to detect each of the bit line voltage levels sequentially.

16. The device of claim 15, wherein a said bit line comprises at least two voltage levels comprised of:
a first voltage level about equal to a power voltage level determined by a pre charged bit line voltage to the power voltage level unchanged by a first data state in the memory element; and
a second voltage level at a detect voltage level of a sense device determined by a pre charged bit line voltage at the power voltage level being discharged during a bit line settling time to reach the detect voltage level by a second data state in the memory element;
wherein, the detect voltage level is preferably about 75% of the power voltage level, and more preferably about 80% of the power voltage level to reduce the said bit line settling time to increase data transfer bandwidth.

17. The device of claim 16, further comprising:
an output node; and
a plurality of latches configurably coupled to the output node, a said latch to store a said detected bit line data state, the plurality of latches storing the plurality of data states in said sequentially connected bit lines to the input node;
wherein, latching a plurality of bit line data states facilitates detecting the plurality of bit line data states at a faster cycle time compared to a word line addressing cycle time and an equal data transfer cycle time to increase data transfer bandwidth.

18. The device of claim 17, wherein the plurality of latches comprises non overlapping data capture pulses, each data capture pulse synchronized with the cyclical connect operation to capture the voltage level of the bit line connected to the sense device input node in a said latch;
wherein, the address selected word line memory element coupled plurality of bit lines settle at a first delay time, and the cyclical sense and latch data capture operates at a second cycle time at least two times, preferably 4 times, and more preferably 2^{N} times faster than the first delay time to increase data bandwidth, where N is an integer greater than two.

19. The device of claim 17, wherein:
the sense node comprises a sense time determined by a first RC time constant; and
the bit line comprises a settling time determined by a second RC time constant, at least 100 times larger than the first RC time constant due to the resistance and capacitance differences between the sense node and bit line;
wherein, sense node connected to a bit line equilibrate at a voltage level nearly equal to the bit line voltage nearly 100 times faster than the settling time due to charge sharing; and
wherein, during a single cache memory address cycle time, a plurality of bit line voltage levels can be detected, and latched, and transferred to an output using a single sense device.

20. The device of claim 19, wherein a said latch output is coupled to a first wire segment to transfer the plurality of sense device latched data, the first wire segment further comprised of:
a first end coupled to a latch output driver, the first end further comprising a means of by passing the sense device and coupling to a said bit line; and
a wire segment length; and
a second end capable of coupling to a second wire segment of equal segment length to relay a signal utilizing a bidirectional latch buffer comprised of:
an input to receive the signal and an output to relay the signal; and
a configurable means of selecting the input and the output to couple to the first and second wire segments to configure the signal direction; and
a detector coupled to the input to detect an input signal transition comprising a trip-point; and
a latch coupled to the detector to store a binary data value based on the transition detection, the latched value buffered at the output to relay the signal;
wherein, the wire segment length and the trip-point facilitate short wire delays to transfer the plurality of latched data to achieve high data transfer bandwidth.
